(19) United States
(12) Patent Application Publication
(10) Pub. No.: US 2014/0213729 A1
(43) Pub. Date: Jul. 31, 2014

(54) CURABLE RESIN COMPOSITION CONTAINING POLYMER MICROPARTICLES

(71) Applicants: KANEKA CORPORATION, Osaka (JP); KANEKA NORTH AMERICA LLC, Pasadena, TX (US)

(72) Inventor: Shin-ya Hongo, Pasadena, TX (US)

(73) Assignees: KANEKA CORPORATION, Osaka (JP); KANEKA NORTH AMERICA LLC, Pasadena, TX (US)

(21) Appl. No.: 14/163,028

(22) Filed: Jan. 24, 2014

Related U.S. Application Data
(60) Provisional application No. 61/756,840, filed on Jan. 25, 2013.

(51) Int. Cl. C08L 9/10

(52) U.S. Cl. CPC C08L 9/10
USPC 525/122; 525/303

(57) ABSTRACT

A curable resin composition which contains a curable resin (A) having two or more polymerizable unsaturated bonds in a molecule, and polymer microparticles (B), and which optionally further contains an epoxy resin (C) and a low-molecular-weight compound (D) having a molecular weight less than 300 and having at least one polymerizable unsaturated bond in a molecule,
wherein the content of component (B) is 1 to 100 parts by mass per 100 parts by mass of the sum of component (A) and component (D),
the content of the epoxy resin (C) is less than 0.5 parts by mass per 100 parts by mass of the sum of component (A) and component (D),
component (A) has an epoxy (meth)acrylate content less than 99 parts by mass per 100 parts by mass of the whole component (A), and
component (B) has been dispersed in the state of primary particles in the curable resin composition.

### CROSS-REFERENCE TO RELATED APPLICATION

This application is entitled to the benefit of U.S. Provisional Patent Application No. 61/756,840, filed Jan. 25, 2013, the content of which is incorporated herein by reference.

### TECHNICAL FIELD

The present invention relates to a radical curing type curable resin composition which is excellent in terms of toughness and cracking resistance.

### BACKGROUND ART

Radical curing type curable resins such as unsaturated polyester resins and vinyl ester resins are widely used in various applications including coating materials and molding compositions containing a reinforcement such as glass fibers.

These curable resins have had a problem in that the curing is accompanied with considerable curing shrinkage and the cured product cracks due to the resultant internal stress. Various attempts have hence been made to impart toughness to these curable resins, which are significantly brittle materials, but the level of the improvements thereof was insufficient.

Patent Literature 1 and Patent Literature 2 disclose techniques in which an epoxy resin and specific crosslinked-rubber particles are added to an unsaturated polyester resin to improve the toughness without causing a deterioration of the surface state of the cured product. However, although the cured products obtained by these methods have improved toughness, there have been cases where, due to the influences of the epoxide remaining unincorporated into the crosslinking of the main-component curable resin, not only the cured products have reduced heat resistance (Tg) and the effect of inhibiting the cured product surface from having tackiness (surface tackiness) is insufficient, but also the cured products are prone to absorb solvents and have reduced chemical resistance.

In applications where high-temperature characteristics are important, a decrease in Tg of about 5° C. may adversely affect the high-temperature characteristics. Meanwhile, Patent Literature 1 and Patent Literature 2 each discloses a resin composition which contains a radical curing type curable resin and an epoxy resin incorporated in an amount of 0.5 parts by weight or more based on the curable resin. However, it was found that incorporation of 0.5 parts by weight or more of the epoxy resin considerably lowers the value of Tg of the cured product to such a degree that the high-temperature characteristics are adversely affected thereby.

Patent Literature 3 discloses a technique in which polymer microparticles are dispersed in the state of primary particles in a vinyl ester resin to improve the toughness. However, with respect to specific examples of the process for producing a vinyl ester resin composition containing polymer microparticles which is described in Patent Literature 3, the only disclosed process is one in which the composition is obtained via a step in which a monocarboxylic acid containing an ethylenically unsaturated double bond is reacted with a polyepoxide containing polymer microparticles. With this production process, the polyepoxide as a starting material inevitably remains in a small amount and, as mentioned above, there have been cases where the residual epoxide adversely affects the properties of the cured product.

Synthesis Examples of Patent Literature 4 specifically describe a step in which a monocarboxylic acid containing an unsaturated double bond, e.g. methacrylic acid, is reacted with an epoxy resin. In these Synthesis Examples, an epoxy resin and each of various carboxylic acids are introduced in equimolar amounts and reacted, and the reaction is terminated at an acid value of 5 mg-KOH/g. In these Synthesis Examples, since an epoxy resin having an epoxy equivalent of 189 is used and the acid value is 5 mg-KOH/g, it is thought that 1.7% by weight of the epoxy resin remains in the liquid resulting from the reaction.

As mentioned above, in cases when a radical curing type curable resin composition contains a large amount of an epoxy resin, there is a fear that the cured product obtained may have reduced heat resistance. In the case of the resin composition described in Patent Literature 3 also, it is predicted that the cured product might have a reduced value of Tg due to the residual epoxy resin.

Meanwhile, Example 4 of Patent Literature 5 discloses an embodiment in which polymer microparticles in a powder state are stirred and mixed with an unsaturated polyester resin to disperse the microparticles in the resin composition. However, polymer microparticles in a powder state generally are aggregate particles obtained by coagulating a latex of a rubbery polymer and then drying the coagulated latex, and there have been cases where resin compositions in which such aggregate particles have been dispersed have a high viscosity.

Meanwhile, cured products obtained by molding, with a mold, a thermosetting resin that cures by a radical polymerization method have problems wherein the secondary adhesion is poor for the reasons, for example, that the surface which was in contact with the mold is a smooth surface and an anchor effect cannot be expected, that since the thermosetting resin is not in contact with air during molding, the curing is prone to proceed too readily to expect chemical bondings, and that since a release agent was applied to the mold, the release agent is adherent also to the molded article. In particular, there was the problem wherein the degree of difficulty of secondary adhesion to unsaturated polyester resins modified with dicyclopendadiene or the like is high.

### CITATION LIST

### Patent Literature

Patent Literature 1: WO 2010/018829
Patent Literature 2: JP-A 2011-140574
Patent Literature 3: WO 2010/143366
Patent Literature 4: JP-A 2005-097523
Patent Literature 5: JP-A 2003-327845

### SUMMARY OF INVENTION

### Problem to be Solved by the Invention

The present invention was achieved in view of the circumstances described above, and an object of the present invention is to provide a curable resin composition which gives a cured product excellent in terms of toughness and cracking resistance without lowering the properties thereof and which has a low viscosity and further has excellent adhesion to the base.

### Solution to Problems

The present inventors diligently made investigations in order to solve such problems. As a result, the inventors have found that the problems are solved by controlling, in a curable resin composition which contains a curable resin (A) having two or more polymerizable unsaturated bonds in a molecule, and polymer microparticles (B) dispersed in the state of primary particles and which optionally further contains an epoxy resin (C) and a low-molecular-weight compound (D) having a molecular weight less than 300 and having at least one polymerizable unsaturated bond in a molecule,

the content of component (B) to be 1 to 100 parts by mass per 100 parts by mass of the sum of component (A) and component (D),

the content of the epoxy resin (C) to be less than 0.5 parts by mass per 100 parts by mass of the sum of component (A) and component (D), and

component (A) to have an epoxy (meth)acrylate content less than 99 parts by mass per 100 parts by mass of the whole component (A). Thus, the present invention has been completed.

Namely, the present invention relates to a curable resin composition which comprises a curable resin (A) having two or more polymerizable unsaturated bonds in a molecule, and polymer microparticles (B), and which optionally further comprises an epoxy resin (C) and a low-molecular-weight compound (D) having a molecular weight less than 300 and having at least one polymerizable unsaturated bond in a molecule,

wherein the content of component (B) is 1 to 100 parts by mass per 100 parts by mass of the sum of component (A) and component (D),

the content of the epoxy resin (C) is less than 0.5 parts by mass per 100 parts by mass of the sum of component (A) and component (D),

component (A) has an epoxy (meth)acrylate content less than 99 parts by mass per 100 parts by mass of the whole component (A), and

component (B) has been dispersed in the state of primary particles in the curable resin composition.

It is preferable that component (A) or a mixture of component (A) and component (D) be liquid at 23° C.

It is preferable that component (A) have a main chain constituted of repeating units which contain ester bonds.

It is preferable that component (A) be an unsaturated polyester.

It is preferable that component (A) be a polyester (meth)acrylate.

It is preferable that component (A) be one or more selected from the group consisting of epoxy (meth)acrylates, urethane (meth)acrylates, polyether (meth)acrylates, and acrylated (meth)acrylates.

It is preferable that the curable resin composition contain no epoxy (meth)acrylate.

It is preferable that component (B) have a volume-average particle diameter of 10 to 2,000 nm.

It is preferable that component (B) have a core/shell structure.

It is preferable that component (B) have a core layer containing at least one rubber selected from the group consisting of diene-based rubbers, (meth)acrylate-based rubbers, and organosiloxane-based rubbers.

It is preferable that the diene-based rubbers be butadiene rubbers and/or butadiene/styrene rubbers.

It is preferable that component (B) have a shell layer formed by graft-polymerizing, with a core layer, at least one monomer component selected from the group consisting of aromatic vinyl monomers, vinyl cyanide monomers, and (meth)acrylate monomers.

It is preferable that component (B) have a shell layer formed by graft-polymerizing, with a core layer, a monomer component which contains a polyfunctional monomer having two or more polymerizable unsaturated bonds.

It is preferable that the curable resin composition do not contain the epoxy resin (C).

It is preferable that component (D) be a (meth) acryloyl-containing compound.

It is preferable that the (meth)acryloyl-containing compound have a hydroxy group.

It is preferable that the curable resin composition further comprise a radical initiator (E).

The present invention further relates to a cured product obtained by curing the curable resin composition of the present invention.

The present invention furthermore relates to a cured product obtained by curing a curable resin composition which contains a curable resin (A) having two or more polymerizable unsaturated bonds in a molecule, and polymer microparticles (B), and which optionally further contains an epoxy resin (C) and a low-molecular-weight compound (D) having a molecular weight less than 300 and having at least one polymerizable unsaturated bond in a molecule,

the content of component (B) being 1 to 100 parts by mass per 100 parts by mass of the sum of component (A) and component (D),

the content of the epoxy resin (C) being less than 0.5 parts by mass per 100 parts by mass of the sum of component (A) and component (D), and

component (A) having an epoxy (meth)acrylate content less than 99 parts by mass per 100 parts by mass of the whole component (A),

wherein component (B) has been dispersed in the state of primary particles.

The present invention still further relates to a process for producing the curable resin composition of the present invention, including:

a first step of mixing an aqueous latex containing component (B) with an organic solvent that has a solubility in 20° C. water of 5 to 40% by mass and thereafter further mixing the mixture with excess water to aggregate component (B);

a second step of separating and recovering the aggregated component (B) from a liquid phase and mixing again the aggregated component (B) with an organic solvent to obtain an organic-solvent dispersion of component (B); and

a third step of further mixing the organic-solvent dispersion with component (A) and/or component (D), and then distilling off the organic solvent.

### Advantageous Effects of Invention

The curable resin composition of the present invention can significantly improve the toughness and cracking resistance of the cured product to be obtained, without lowering the heat resistance (Tg), transparency, modulus, surface non-tackiness, and weatherability (non-yellowing properties). This composition has a low viscosity and can further have improved adhesion to the base.

### BRIEF DESCRIPTION OF DRAWINGS

FIG. 1 is a transmission electron microscope photograph (×10,000) which shows the dispersed state of the polymer microparticles contained in the cured product obtained in Example 28.

FIG. 2 is a transmission electron microscope photograph (×40,000) which shows the dispersed state of the polymer microparticles contained in the cured product obtained in Example 28.

FIG. 3 is a transmission electron microscope photograph (×10,000) which shows the dispersed state of the polymer microparticles contained in the cured product obtained in Comparative Example 22.

### DESCRIPTION OF EMBODIMENTS

The curable resin composition of the present invention will be explained below in detail.

The curable resin composition of the present invention contains a curable resin (A) having two or more polymerizable unsaturated bonds in the molecule, and polymer microparticles (B) and may further contain an epoxy resin (C) and a low-molecular-weight compound (D) having a molecular weight less than 300 and having at least one polymerizable unsaturated bond in the molecule.

### <Curable Resin (a) Having Two or More Polymerizable Unsaturated Bonds in the Molecule>

The curable resin (A) having two or more polymerizable unsaturated bonds in the molecule used in the present invention is not particularly limited, and examples thereof include curable resins having radical-polymerizable carbon-carbon double bonds. More specific examples thereof include curable resins having a main chain which is constituted of repeating units that contain ester bonds, such as unsaturated polyester resins and polyester (meth)acrylates, and further include epoxy (meth)acrylates, urethane (meth)acrylates, polyether (meth)acrylates, and acrylated (meth)acrylates. These may be used alone or in combination.

Among them, from the standpoint of profitability, preferable are curable resins having a main chain which is constituted of repeating units that contain ester bonds, epoxy (meth)acrylates, and urethane (meth)acrylates. Curable resins having a main chain which is constituted of repeating units that contain ester bonds and urethane (meth)acrylates are more preferable because use of these curable resins results in a low residual epoxide content. Furthermore, from the standpoint of heat resistance, even more preferable are curable resins having a main chain which is constituted of repeating units that contain ester bonds. From the standpoints of high curability during radical curing, the weatherability and discoloration of the cured product to be obtained, easy dispersibility of the polymer microparticles of component (B), etc., polyester (meth)acrylates are especially preferable.

The epoxy (meth)acrylates are addition reaction products obtained by causing a polyepoxide such as bisphenol A epoxy resin to undergo addition reaction with an unsaturated monobasic acid such as (meth)acrylic acid and optionally with a polybasic acid in the presence of a catalyst. These addition reaction products, including mixtures each obtained by mixing the addition reaction product with a vinyl monomer if necessary, are generally called vinyl ester resins. With this production process, the polyepoxide as a starting material inevitably remains in a small amount. In the case where the polyepoxide has no polymerizable unsaturated bond in the molecule, there are cases where the polyepoxide does not cure and remains, adversely affecting the properties (heat resistance, etc.) of the cured product. From the standpoint that the residual epoxide is diminished and from the standpoint of profitability, it is essential in the curable resin composition of the present invention that component (A) has an epoxy (meth)acrylate content less than 99 parts by mass per 100 parts by mass of the whole component (A). The epoxy (meth)acrylate content thereof is preferably less than 95 parts by mass, more preferably less than 90 parts by mass, even more preferably less than 80 parts by mass, especially preferably less than 50 parts by mass, and most preferably less than 30 parts by mass. It is more preferable that the curable resin composition of the present invention contain no epoxy (meth)acrylate.

The curable resins having a main chain which is constituted of repeating units that contain ester bonds are not particularly limited so long as the curable resins are curable compounds each having an ester group and two or more polymerizable unsaturated bonds in the molecule. Examples thereof include unsaturated polyesters and polyester (meth)acrylates.

### <<Unsaturated Polyesters>>

The unsaturated polyesters are not particularly limited, and examples thereof include ones obtained by the condensation reaction of a polyhydric alcohol with an unsaturated polyvalent carboxylic acid or the anhydride thereof.

Examples of the polyhydric alcohol include dihydric alcohols having 2 to 12 carbon atoms, such as ethylene glycol, 1,2-propylene glycol, 1,3-propylene glycol, diethylene glycol, dipropylene glycol, 1,4-butanediol, and neopentyl glycol. Preferable are dihydric alcohols having 2 to 6 carbon atoms. More preferable is propylene glycol. These dihydric alcohols may be used alone or in combination of two or more thereof.

Examples of the unsaturated polyvalent carboxylic acid include divalent carboxylic acids having 3 to 12 carbon atoms. More preferable are divalent carboxylic acids having 4 to 8 carbon atoms. Specific examples thereof include fumaric acid and maleic acid. These divalent carboxylic acids may be used alone or in combination of two or more thereof.

In the present invention, a saturated polyvalent carboxylic acid or the anhydride thereof may be used in combination with the unsaturated polyvalent carboxylic acid or anhydride thereof. In this case, it is preferable that the unsaturated polyvalent carboxylic acid or anhydride thereof be contained in an amount of at least 30% by mole relative to the whole amount of polyvalent carboxylic acid or anhydride thereof. Examples of the saturated polyvalent carboxylic acid or anhydride thereof include phthalic anhydride, terephthalic acid, isophthalic acid, adipic acid, and glutaric acid. These saturated polyvalent carboxylic acids or anhydrides thereof may be used alone or in combination of two or more thereof.

The unsaturated polyesters can be obtained by subjecting the polyhydric alcohol, the unsaturated polyvalent carboxylic acid or anhydride thereof, etc. to condensation reaction in the presence of an esterification catalyst such as an organic titanic acid salt, e.g. tetrabutyl titanate, or an organotin compound, e.g. dibutyltin oxide.

The curable unsaturated polyester compounds are also commercially available from, for example, Ashland Inc., Reichhold Inc., and AOC Ltd.

The number-average molecular weight of the unsaturated polyesters is not particular limited, and is preferably 400 to 10,000, more preferably 450 to 5,000, especially preferably 500 to 3,000.

### <<Polyester (Meth)Acrylates>>

The polyester (meth)acrylates are not particularly limited, and examples thereof include ones obtained by esterifying a polyvalent carboxylic acid having a valence of 2 or higher or the anhydride thereof, a (meth)acryloyl-containing unsaturated monocarboxylic acid, and a polyhydric alcohol having a valence of 2 or higher as essential components. Alternatively, the polyester (meth)acrylates can be obtained, for example, by subjecting a polyvalent carboxylic acid or the anhydride thereof to condensation reaction with a polyhydric alcohol and subjecting a hydroxy group of the resultant polyester to esterification reaction with an unsaturated monocarboxylic acid. Furthermore, the polyester (meth)acrylates can be obtained, for example, by subjecting a polyvalent carboxylic acid or the anhydride thereof to condensation reaction with a polyhydric alcohol and subjecting a carboxyl group of the resultant polyester to esterification reaction with an unsaturated glycidyl ester compound.

Examples of the polyvalent carboxylic acid or anhydride thereof include unsaturated carboxylic acids or anhydrides thereof, such as maleic acid, maleic anhydride, fumaric acid, itaconic acid, itaconic anhydride, and citraconic acid. Examples thereof further include saturated carboxylic acids or anhydrides thereof, such as phthalic acid, phthalic anhydride, isophthalic acid, terephthalic acid, tetrahydrophthalic acid, tetrahydrophthalic anhydride, hexahydrophthalic acid, hexahydrophthalic anhydride, cyclohexanedicarboxylic acid, succinic acid, malonic acid, glutaric acid, adipic acid, azelaic acid, sebacic acid, 1,12-dodecanedioic acid, dimer acids, 2,6-naphthalenedicarboxylic acid, 2,7-naphthalenedicarboxylic acid, 2,3-naphthalenedicarboxylic acid, 2,3-naphthalenedicarboxylic anhydride, and 4,4′-biphenyldicarboxylic acid.

Preferable of these are maleic anhydride, fumaric acid, itaconic acid, phthalic anhydride, isophthalic acid, terephthalic acid, tetrahydrophthalic anhydride, adipic acid, and sebacic acid. More preferable are phthalic anhydride, isophthalic acid, and terephthalic acid. Isophthalic acid is especially preferable because this acid gives component (A) having a low viscosity and also from the standpoint of the water resistance of the cured product.

Examples of the polyhydric alcohol include ethylene glycol, diethylene glycol, triethylene glycol, tetraethylene glycol, propylene glycol, dipropylene glycol, 1,3-butanediol, 1,4-butanediol, 1,5-pentanediol, 1,6-hexanediol, neopentyl glycol, 1,4-cyclohexanediol, 1,3-cyclohexanediol, 1,2-cyclohexanediol, 1,4-cyclohexanedimethanol, 2-methylpropane-1,3-diol, hydrogenated bisphenol A, adducts of bisphenol A with an alkylene oxide such as propylene oxide or ethylene oxide, and trimethylolpropane.

Among them, preferable are ethylene glycol, diethylene glycol, propylene glycol, dipropylene glycol, 1,3-butanediol, 1,4-butanediol, 1,6-hexanediol, neopentyl glycol, hydrogenated bisphenol A, and adducts of bisphenol A with propylene oxide. More preferable are propylene glycol, neopentyl glycol, hydrogenated bisphenol A, and adducts of bisphenol A with propylene oxide. Neopentyl glycol is especially preferable because this alcohol gives component (A) having a low viscosity and also from the standpoint of the water resistance and weatherability of the cured product.

For conducting the condensation reaction, etc., known methods can be used. The mixing ratio of the polyvalent carboxylic acid compound and the polyhydric alcohol compound is not particularly limited. The presence or absence of other additives, e.g. a catalyst and a defoaming agent, and the amounts thereof are also not particularly limited. Furthermore, reaction temperatures and reaction times in the reactions may be suitably set so as to complete the reactions.

The unsaturated monocarboxylic acid is a monobasic acid having at least one (meth)acryloyl group in the molecule. Examples thereof include acrylic acid, methacrylic acid, crotonic acid, cinnamic acid, sorbic acid, mono-2-(methacryloyloxy)ethyl maleate, mono-2-(acryloyloxy)ethyl maleate, mono-2-(methacryloyloxy)propyl maleate, and mono-2-(acryloyloxy)propyl maleate.

The unsaturated glycidyl ester compound is a glycidyl ester compound having at least one (meth)acryloyl group in the molecule. Examples thereof include glycidyl acrylate and glycidyl methacrylate.

For the esterification reaction, it is preferable to add a polymerization inhibitor or molecular oxygen in order to prevent gelation due to the polymerization.

The polymerization inhibitor is not particularly limited, and a conventionally known compound can be used. Examples thereof include hydroquinone, methylhydroquinone, p-t-butylcatechol, 2-t-butylhydroquinone, toluhydroquinone, p-benzoquinone, naphthoquinone, methoxyhydroquinone, phenothiazine, hydroquinone monomethyl ether, trimethylhydroquinone, methylbenzoquinone, 2,6-di-t-butyl-4-(dimethylaminomethyl)phenol, 2,5-di-t-butylhydroquinone, 4-hydroxy-2,2,6,6-tetramethylpiperidin-1-oxyl, and copper naphthenate.

As the molecular oxygen, either air or a gas mixture of air and an inert gas such as nitrogen can, for example, be used. In this case, such a gas may be blown (so-called bubbling) into the reaction system. Incidentally, it is preferable that in order to sufficiently prevent gelation due to the polymerization, a polymerization inhibitor and molecular oxygen be used in combination.

The reaction conditions including reaction temperature and reaction time in the esterification reaction may be suitably set so as to complete the reaction, and are not particularly limited. It is preferable to use the above esterification catalyst in order to accelerate the reaction. For the esterification reaction, a solvent may be used if necessary. Examples of the solvent include, but not particularly limited to, aromatic hydrocarbons such as toluene. The amount of the solvent to be used and methods for removing the solvent after the reaction are not particularly limited. Incidentally, since water is formed as a by-product in the esterification reaction, it is preferable to remove the by-product water from the reaction system in order to accelerate the reaction. Methods for the removal are not particularly limited.

The number-average molecular weight of the polyester (meth)acrylates is not particularly limited, and is preferably 400 to 10,000, more preferably 450 to 5,000, and especially preferably 500 to 3,000.

### <<Epoxy (Meth)Acrylates>>

The epoxy (meth)acrylates are not particularly limited, and can be obtained, for example, by subjecting a polyfunctional epoxy compound having two or more epoxy groups in the molecule to esterification reaction with an unsaturated monocarboxylic acid and optionally with a polyvalent carboxylic acid in the presence of an esterification catalyst.

Examples of the polyfunctional epoxy compound include bisphenol epoxy compounds, novolac epoxy compounds, hydrogenated bisphenol epoxy compounds, hydrogenated novolac epoxy compounds, and halogenated epoxy compounds formed by replacing part of the hydrogen atoms possessed by the above bisphenol epoxy compounds or novolac epoxy compounds with halogen atoms (e.g. bromine atoms, chlorine atoms, etc.). One of these polyfunctional epoxy compounds may be used alone, or two or more thereof may be used in combination.

Examples of the bisphenol epoxy compounds include glycidyl ether epoxy compounds obtained by the reaction of epichlorohydrin or methylepichlorohydrin with bisphenol A or bisphenol F or epoxy compounds obtained by the reaction of a bisphenol A/alkylene oxide adduct with epichlorohydrin or methylepichlorohydrin.

Examples of the hydrogenated bisphenol epoxy compounds include glycidyl ether epoxy compounds obtained by the reaction of epichlorohydrin or methylepichlorohydrin with hydrogenated bisphenol A or hydrogenated bisphenol F or epoxy compounds obtained by the reaction of a hydrogenated bisphenol A/alkylene oxide adduct with epichlorohydrin or methylepichlorohydrin.

Examples of the novolac epoxy compounds include epoxy compounds obtained by the reaction of a phenol novolac or a cresol novolac with epichlorohydrin or methylepichlorohydrin.

Examples of the hydrogenated novolac epoxy compounds include epoxy compounds obtained by the reaction of a hydrogenated phenol novolac or a hydrogenated cresol novolac with epichlorohydrin or methylepichlorohydrin.

The average epoxy equivalent of the polyfunctional epoxy compounds is preferably in the range of 150 to 900, and especially preferably in the range of 150 to 400. Epoxy (meth)acrylates obtained using a polyfunctional epoxy compound that has an average epoxy equivalent exceeding 900 are prone to have reduced reactivity and are prone to reduce the curability of the composition. Meanwhile, in the case of using a polyfunctional epoxy compound having an average epoxy equivalent less than 150, the composition is prone to have inferior properties.

The unsaturated monocarboxylic acid is a monobasic acid having at least one (meth)acryloyl group in the molecule. Examples thereof include acrylic acid and methacrylic acid. It is also possible to replace part of these unsaturated monocarboxylic acids with any of cinnamic acid, crotonic acid, sorbic acid, and a half ester of an unsaturated dibasic acid (mono-2-(methacryloyloxy)ethyl maleate, mono-2-(acryloyloxy)ethyl maleate, mono-2-(methacryloyloxy)propyl maleate, mono-2-(acryloyloxy)propyl maleate, etc.).

Examples of the polyvalent carboxylic acid include maleic acid, maleic anhydride, fumaric acid, itaconic acid, itaconic anhydride, citraconic acid, adipic acid, azelaic acid, phthalic acid, phthalic anhydride, isophthalic acid, terephthalic acid, trimellitic anhydride, hexahydrophthalic anhydride, 1,6-cyclohexanedicarboxylic acid, dodecanedioic acid, and dimer acids.

With respect to the proportion of the sum of the unsaturated monocarboxylic acid and the polyvalent carboxylic acid, which is used when needed, to the polyfunctional epoxy compound, it is preferable that the ratio of the total carboxyl groups possessed by the unsaturated monocarboxylic acid and the polyvalent carboxylic acid to the epoxy groups of the polyfunctional epoxy compound be in the range of 1:1.2 to 1.2:1.

As the esterification catalyst, a conventionally known compound can be used. Examples thereof include: tertiary amines such as triethylamine, N,N-dimethylbenzylamine, and N,N-dimethylaniline; quaternary ammonium salts such as trimethylbenzylammonium chloride and pyridinium chloride; phosphonium compounds such as triphenylphosphine, tetraphenylphosphonium chloride, tetraphenylphosphonium bromide, and tetraphenylphosphonium iodide; sulfonic acids such as p-toluenesulfonic acid; and organometal salts such as zinc octenoate.

Reaction methods, reaction conditions, etc. for conducting the reaction are not particularly limited. In the esterification reaction, it is more preferable to add a polymerization inhibitor or molecular oxygen to the reaction system in order to prevent gelation due to the polymerization. As the polymerization inhibitor and the molecular oxygen, those mentioned above in relation to the polyester (meth)acrylates can be used in the same manner.

The number-average molecular weight of the epoxy (meth)acrylates is not particularly limited, and is preferably 300 to 10,000, more preferably 350 to 5,000, and especially preferably 400 to 2,500.

### <<Urethane (Meth)Acrylates>>

The urethane (meth)acrylates are not particularly limited, and examples thereof include ones obtained by subjecting a polyisocyanate compound, a polyol compound, and a hydroxy-containing (meth)acrylate compound to urethanation reaction. Examples thereof further include ones obtained by subjecting a polyol compound and a (meth)acryloyl-containing isocyanate compound to urethanation reaction and ones obtained by subjecting a hydroxy-containing (meth)acrylate compound and a polyisocyanate compound to urethanation reaction.

Examples of the polyisocyanate compound include: 2,4-tolylene diisocyanate and hydrogenation products thereof, isomers of 2,4-tolylene diisocyanate and hydrogenation products thereof, diphenylmethane diisocyanate, hydrogenated diphenylmethane diisocyanate, hexamethylene diisocyanate, the trimer of hexamethylene diisocyanate, isophorone diisocyanate, xylene diisocyanate, hydrogenated xylene diisocyanate, dicyclohexylmethane diisocyanate, tolidine diisocyanate, naphthalene diisocyanate, and triphenylmethane triisocyanate; and Millionate MR and Coronate L (manufactured by Nippon Polyurethane Industry Co., Ltd.), Burnock D-750 and Crisvon NX (manufactured by DIC Corporation), Desmodule L (manufactured by Sumitomo Bayer Co., Ltd.), and Takenate D102 (manufactured by Takeda Chemical Industries, Ltd.).

Examples of the polyol compound include polyether polyols, polyester polyols, polybutadiene polyols, and adducts of bisphenol A with an alkylene oxide such as propylene oxide or ethylene oxide. The number-average molecular weight of the polyether polyols is preferably in the range of 300 to 5,000, and especially preferably in the range of 500 to 3,000. Examples thereof include polyoxyethylene glycol, polyoxypropylene glycol, polytetramethylene glycol, and polyoxymethylene glycol. The number-average molecular weight of the polyester polyols is preferably in the range of 1,000 to 3,000.

The hydroxy-containing (meth)acrylate compound is a (meth)acrylate compound which has at least one hydroxy group in the molecule. Examples of the hydroxy-containing (meth)acrylate compound include 2-hydroxyethyl (meth)acrylate, 2-hydroxypropyl (meth)acrylate, 3-hydroxybutyl (meth)acrylate, polyethylene glycol mono(meth)acrylate, and polypropylene glycol mono(meth)acrylate.

The (meth)acryloyl-containing isocyanate compound is a compound of the type which contains both at least one (meth)acryloyl group and an isocyanate group in the molecule. Examples thereof include 2-(meth)acryloyloxymethyl isocyanate, 2-(meth)acryloyloxyethyl isocyanate, and compounds obtained by subjecting a hydroxy-containing (meth)acrylate compound and a polyisocyanate to urethanation reaction in a molar ratio of 1:1.

Reaction methods in the urethanation reaction are not particularly limited, and reaction conditions including reaction temperature and reaction time may be suitably set so as to complete the reaction and are not particularly limited. For example, in cases when a polyisocyanate compound, a polyol compound, and a hydroxy-containing (meth)acrylate compound are subjected to urethanation reaction, the polyisocyanate compound and the polyol compound are first subjected to urethanation reaction wherein the ratio of the isocyanate groups possessed by the former compound to the hydroxy groups possessed by the latter compound (isocyanate groups/hydroxy groups) is in the range of 3.0 to 2.0, thereby forming a prepolymer having isocyanate groups at the ends, and subsequently a urethanation reaction is conducted wherein the amount of the hydroxy groups possessed by the hydroxy-containing (meth)acrylate is approximately equivalent to that of the isocyanate groups possessed by the prepolymer.

For the above reaction, it is preferable to use a urethanation catalyst in order to accelerate the urethanation reaction. Examples of the urethanation catalyst include tertiary amines such as triethylamine and metal salts such as di-n-butyltin dilaurate. Any of ordinary urethanation catalysts can be used. For the above reaction, it is preferable to add a polymerization inhibitor or molecular oxygen in order to prevent gelation due to the polymerization. As the polymerization inhibitor and the molecular oxygen, those mentioned above in relation to the polyester (meth)acrylates can be used in the same manner.

The number-average molecular weight of the urethane (meth)acrylates is not particularly limited, and is preferably 400 to 10,000, more preferably 800 to 8,000, and especially preferably 1,000 to 5,000.

### <Polymer Microparticles (B)>

It is essential that the curable resin composition of the present invention contains polymer microparticles (B) in an amount of 1 to 100 parts by mass per 100 parts by mass of the sum of component (A) and component (D), which is described later, and that this component (B) has been dispersed in the state of primary particles in the curable resin composition. Due to the toughness-improving effect of component (B), the cured product to be obtained is excellent in terms of toughness and cracking resistance.

Furthermore, the addition of component (B) significantly improves the adhesion of the curable resin composition of the present invention to bases. Moreover, since component (B) has been dispersed in the state of primary particles, a cured product having enhanced transparency and satisfactory surface properties (reduced in surface irregularities) is obtained. The composition before curing has a low viscosity and has satisfactory handleability.

From the standpoint of a balance between the handleability of the curable resin composition to be obtained and the effect of improving the toughness of the cured product to be obtained, the content of component (B) is preferably 2 to 70 parts by mass, more preferably 3 to 50 parts by mass, especially preferably 4 to 20 parts by mass, per 100 parts by mass of the sum of component (A) and component (D).

The particle diameter of the polymer microparticles is not particularly limited, but in view of industrial productivity, the volume-average particle diameter (Mv) thereof is preferably 10 to 2,000 nm, more preferably 30 to 600 nm, even more preferably 50 to 400 nm, and especially preferably 100 to 200 nm. Incidentally, the volume-average particle diameter (Mv) of polymer particles can be determined using Microtrac UPA150 (manufactured by Nikkiso Co., Ltd.).

In the curable resin composition of the present invention, it is preferable that component (B) have a number-based particle diameter distribution which has a half-value width that is 0.5 to 1 time the volume-average particle diameter, from the standpoint of obtaining a curable resin composition that has a low viscosity and is easy to handle.

Furthermore, from the standpoint of easily achieving the aforementioned specific particle diameter distribution, it is preferable that the number-based particle diameter distribution of component (B) have two or more maximum values. From the standpoints of labor saving during production and cost, the particle diameter distribution thereof more preferably has two to three maximum values, and even more preferably has two maximum values. In particular, it is preferable that component (B) contain 10 to 90% by mass polymer microparticles whose volume-average particle diameter is at least 10 nm and less than 150 nm, and 90 to 10% by mass polymer microparticles whose volume-average particle diameter is 150 to 2,000 nm.

The expression “polymer microparticles have been dispersed in the state of primary particles in the curable resin composition” (hereinafter, also referred to as “primarily dispersed”) in the present invention means that the polymer microparticles are substantially independently dispersed (without being in contact with each other nor having been aggregated). It is very difficult to examine the dispersion state of the polymer microparticles contained in a curable resin composition. Hence, the dispersion state can be ascertained, for example, by diluting a portion of the curable resin composition with a solvent such as methyl ethyl ketone and examining the particle diameter of microparticles in the dilution by using, for example, a particle diameter analyzer based on laser light scattering. Alternatively, the dispersed state can be easily ascertained by curing the curable resin composition and thereafter examining the cured product using a transmission electron microscope (TEM). In case where the polymer microparticles have been aggregated in the composition, the aggregates cannot be separated into the primary particles even when the composition is diluted with a solvent because the aggregates have extremely high cohesive force. Unless the polymer microparticles have been primarily dispersed in the uncured composition, there is no possibility that the polymer microparticles will be in a primarily dispersed state after curing. So long as the polymer microparticles have been primarily dispersed in the cured product, the polymer microparticles should be in the primarily dispersed state also in the uncured composition.

In the case where polymer microparticles are steadily in the state of dispersed primary particles over a long period under ordinary conditions without suffering aggregation, separation, or sedimentation within the continuous layer, this means that the polymer microparticles retain dispersion stability. It is preferable that the distribution of the polymer microparticles contained in the continuous layer also do not change substantially and that the polymer microparticles be able to retain the stably dispersed state even when the composition is heated within a riskless range to lower the viscosity and then stirred.

The structure of the polymer microparticles is not particularly limited, and it is preferable that the microparticles have a core/shell structure constituted of two or more layers. Furthermore, the microparticles can have a structure constituted of at least three layers containing a core layer, an interlayer which covers the core layer, and a shell layer which covers the interlayer.

The layers will be specifically explained below.

### <<Core Layer>>

It is preferable that the core layer be an elastic core layer having rubbery properties, from the standpoint of increasing the toughness of the cured product. In order for the elastic core layer to have rubbery properties, it is preferable that a gel content of the elastic core layer be 60% by mass or higher, more preferably 80% by mass or higher, even more preferably 90% by mass or higher, and especially preferably 95% by mass or higher. Incidentally, the term “gel content” herein means the proportion of insoluble matter relative to the sum of the insoluble matter and soluble matter in the case where 0.5 g of crumbs obtained by coagulation and drying are immersed in 100 g of toluene and the mixture is allowed to stand at 23° C. for 24 hours and then separated into the soluble matter and the insoluble matter.

Examples of polymers capable of forming the elastic core layer having rubbery properties include: natural rubber, a diene-based rubber or (meth)acrylate-based rubber obtained from a monomer composition containing 50 to 100% by mass of at least one monomer (first monomer) selected from diene monomers (conjugated diene monomers) and (meth)acrylate monomers and 0 to 50% by mass of other copolymerizable vinyl monomer(s) (second monomer); an organosiloxane-based rubber; and combinations of these. From the standpoint of the toughness-improving effect on the cured product to be obtained, a diene-based rubber obtained from one or more diene monomers is preferable. Furthermore, from the standpoint of the weatherability of the cured product to be obtained, a (meth)acrylate-based rubber obtained from one or more (meth)acrylate monomers is preferable. In cases when the impact resistance at low temperatures of the cured product is to be improved without lowering the heat resistance, it is preferable that the elastic core layer be an elastomer of an organosiloxane-based rubber. Incidentally, the term “(meth)acrylate” herein means acrylate and/or methacrylate.

Examples of the monomers (conjugated-diene monomers) for constituting the diene-based rubber for use as the elastic core layer include 1,3-butadiene, isoprene, 2-chloro-1,3-butadiene, and 2-methyl-1,3-butadiene. These diene monomers may be used alone or in combination of two or more thereof.

From the standpoint of the toughness-improving effect, the diene-based rubber is preferably either butadiene rubber, which is obtained from 1,3-butadiene, or butadiene/styrene rubbers, which are copolymers of 1,3-butadiene and styrene, and butadiene rubber is more preferable. Butadiene/styrene rubbers are more preferable because the transparency of the cured product to be obtained can be heightened by controlling the refractive index.

Examples of the monomers which constitutes the (meth)acrylate-based rubber used in the elastic core layer include: alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate and behenyl (meth)acrylate; aromatic-ring-containing (meth)acrylates such as phenoxyethyl (meth)acrylate and benzyl (meth)acrylate; hydroxyalkyl (meth)acrylates such as 2-hydroxyethyl (meth)acrylate and 4-hydroxybutyl (meth)acrylate; glycidyl (meth)acrylates such as glycidyl (meth)acrylate and glycidylalkyl (meth)acrylates; alkoxyalkyl (meth)acrylates; allylalkyl (meth)acrylates such as allyl (meth)acrylate and allylalkyl (meth)acrylates; and polyfunctional (meth)acrylates such as monoethylene glycol di(meth)acrylate, triethylene glycol di(meth)acrylate and tetraethylene glycol di(meth)acrylate. These (meth)acrylate monomers may be used alone or in combination of two or more thereof. Especially preferable are ethyl (meth)acrylate, butyl (meth)acrylate and 2-ethylhexyl (meth)acrylate.

Examples of the vinyl monomer(s) (second monomer) copolymerizable with the first monomer include: vinylarenes such as styrene, α-methylstyrene, monochlorostyrene and dichlorostyrene; vinylcarboxylic acids such as acrylic acid and methacrylic acid; vinyl cyanides such as acrylonitrile and methacrylonitrile; halogenated vinyls such as vinyl chloride, vinyl bromide and chloroprene; vinyl acetate; alkenes such as ethylene, propylene, butylene and isobutylene; and polyfunctional monomers such as diallyl phthalate, triallyl cyanurate, triallyl isocyanurate and divinylbenzene. These vinyl monomers may be used alone or in combination of two or more thereof. Especially preferable is styrene.

Examples of the organosiloxane-based rubber capable of constituting the elastic core layer include polysiloxane polymers constituted of silyloxy units substituted with two alkyl or aryl groups, such as dimethylsilyloxy, diethylsilyloxy, methylphenylsilyloxy, diphenylsilyloxy and dimethylsilyloxy-diphenylsilyloxy, and polysiloxane polymers constituted of silyloxy units substituted with one alkyl or aryl group, such as an organohydrogensilyloxy formed by replacing part of the side-chain alkyls with a hydrogen atom. These polysiloxane polymers may be used alone or in combination of two or more thereof. Preferable of these, from the standpoint of impartation of heat resistance to the cured product, are dimethylsilyloxy, methylphenylsilyloxy, and dimethylsilyloxy-diphenylsilyloxy. Dimethylsilyloxy is most preferable from the standpoints of availability and profitability.

In the embodiment in which the elastic core layer is constituted of an organosiloxane-based rubber elastomer, it is preferable that the polysiloxane polymer moieties be contained in an amount of 80% by mass or larger (more preferably 90% by mass or larger) per 100% by mass of the whole elastomer from the standpoint of not impairing the heat resistance of the cured product.

From the standpoint of maintaining the dispersion stability of the polymer microparticles in the curable resin composition, it is preferable in the core layer that a crosslinked structure has been introduced into the polymer component obtained by polymerizing the monomers or into the polysiloxane polymer component. As a method for introducing a crosslinked structure, an ordinarily used technique can be adopted. Examples of methods for introducing a crosslinked structure into the polymer component obtained by polymerizing the monomers (diene-based rubber or (meth)acrylate-based rubber) include a method in which a crosslinking monomer, such as a polyfunctional monomer or a mercapto-containing compound, is added to the polymer component and subsequently polymerized. Examples of methods for introducing a crosslinked structure into the polysiloxane polymer include: a method in which a polyfunctional alkoxysilane compound is used as part of the monomers during polymerization; a method in which a reactive group such as a vinyl reactive group or a mercapto group is introduced into a polysiloxane polymer and thereafter a vinyl-polymerizable monomer or an organic peroxide is added to cause radical reaction; and a method in which a crosslinking monomer, such as a polyfunctional monomer or a mercapto-containing compound, is added to a polysiloxane polymer and subsequently polymerized.

Examples of the polyfunctional monomer do not include butadiene and do include: allylalkyl (meth)acrylates such as allyl (meth)acrylate and allylalkyl (meth)acrylates; allyloxyalkyl (meth)acrylates; polyfunctional (meth)acrylates having two or more (meth)acryl groups, such as (poly)ethylene glycol di(meth)acrylate, butanediol di(meth)acrylate, ethylene glycol di(meth)acrylate, triethylene glycol di(meth)acrylate, and tetraethylene glycol di(meth)acrylate; and diallyl phthalate, triallyl cyanurate, triallyl isocyanurate, and divinylbenzene. Especially preferable are allyl methacrylate, triallyl isocyanurate, butanediol di(meth)acrylate, and divinylbenzene.

In the present invention, the core layer has a glass transition temperature (hereinafter, sometimes simply referred to as “Tg”) of preferably 0° C. or lower, more preferably −20° C. or lower, even more preferably −40° C. or lower, especially preferably −60° C. or lower, from the standpoint of increasing the toughness of the cured product to be obtained.

Meanwhile, when it is desired to inhibit a decrease of the modulus (rigidity) of the cured product to be obtained, the Tg of the core layer is preferably higher than 0° C., more preferably 20° C. or higher, even more preferably 50° C. or higher, especially preferably 80° C. or higher, and most preferably 120° C. or higher.

Examples of the polymer having a Tg higher than 0° C. and capable of forming a core layer capable of inhibiting a decrease of the rigidity of the cured product to be obtained include a polymer configured from 50 to 100% by mass (more preferably 65 to 99% by mass) of at least one monomer which gives a homopolymer having a Tg higher than 0° C. and 0 to 50% by mass (more preferably 1 to 35% by mass) of at least one monomer which gives a homopolymer having a Tg lower than 0° C.

Also in the case wherein the core layer has a Tg higher than 0° C., it is preferable that a crosslinked structure have been introduced into the core layer. Examples of methods for introducing the crosslinked structure include the aforementioned methods.

Examples of the monomer which gives a homopolymer having a Tg higher than 0° C. include the following monomers, but the monomer should not be construed as being limited to the following. Examples thereof include: non-substituted vinylaromatic compounds such as styrene and 2-vinylnaphthalene; vinyl-substituted aromatic compounds such as α-methylstyrene; ring-alkylated vinylaromatic compounds such as 3-methylstyrene, 4-methylstyrene, 2,4-dimethylstyrene, 2,5-dimethylstyrene, 3,5-dimethylstyrene, and 2,4,6-trimethylstyrene; ring-alkoxylated vinylaromatic compounds such as 4-methoxystyrene and 4-ethoxystyrene; ring-halogenated vinylaromatic compounds such as 2-chlorostyrene and 3-chlorostyrene; ring-ester-substituted vinylaromatic compounds such as 4-acetoxystyrene; ring-hydroxylated vinylaromatic compounds such as 4-hydroxystyrene; vinyl esters such as vinyl benzoate and vinyl cyclohexanoate; vinyl halides such as vinyl chloride; aromatic monomers such as acenaphthalene and indene; alkyl methacrylates such as methyl methacrylate, ethyl methacrylate, and isopropyl methacrylate; aromatic methacrylates such as phenyl methacrylate; methacrylates such as isobornyl methacrylate and trimethylsilyl methacrylate; methacrylic monomers including methacrylic acid derivatives, such as methacrylonitrile; a certain kind of acrylic esters such as isobornyl acrylate and tert-butyl acrylate; and acrylic monomers including acrylic acid derivatives, such as acrylonitrile. Examples thereof further include monomers which give a Tg of 120° C. or higher, such as acrylamide, isopropylacrylamide, N-vinylpyrrolidone, isobornyl methacrylate, dicyclopentanyl methacrylate, 2-methyl-2-adamantyl methacrylate, 1-adamantyl acrylate, and 1-adamantyl methacrylate.

The monomer which gives a homopolymer having a Tg lower than 0° C. is not particularly limited, and examples thereof include monomers which constitute diene-based rubber polymers, acrylic rubber polymers, organosiloxane-based rubber polymers, polyolefin rubbers formed by olefin compound polymerization, aliphatic polyesters such as polycaprolactone, and polyethers such as polyethylene glycol and polypropylene glycol.

It is preferable that the volume-average particle diameter of core layer be 0.03 to 2 μm, and more preferably 0.05 to 1 μm. There are often cases where it is difficult to stably obtain a core layer having a volume-average particle diameter smaller than 0.03 μm. Volume-average particle diameters thereof exceeding 2 μm have the fear of resulting in deteriorations in the heat resistance and impact resistance of the final molded product. Incidentally, the volume-average particle diameter can be determined using Microtrac UPA150 (manufactured by Nikkiso Co., Ltd.).

The proportion of the core layer is preferably 40 to 97% by mass, more preferably 60 to 95% by mass, even more preferably 70 to 93% by mass, especially preferably 80 to 90% by mass, per 100% by mass of the whole polymer particles. Core-layer proportions less than 40% by mass may result in a decrease of the effect of improving the toughness of the cured product. Core-layer proportions higher than 97% by mass may result in cases where the polymer microparticles are prone to aggregate to make the curable resin composition have an increased viscosity and be difficult to handle.

In the present invention, the core layer has a single-layer structure in many cases, but may have a multilayer structure. When the core layer has a multilayer structure, each layer may differ in polymer composition.

### <<Interlayer>>

In the present invention, an interlayer may be formed if necessary. In particular, the interlayer may be a crosslinked-rubber-surface layer.

Preferable as the crosslinked-rubber-surface layer is one constituted of an interlayer polymer obtained by polymerizing a crosslinked-rubber-surface layer component containing 30 to 100% by weight of polyfunctional monomer having two or more radical-polymerizable carbon-carbon double bonds in the same molecule and 0 to 70% by weight of other vinyl monomer(s).

The interlayer has the effect of lowering the viscosity of the curable resin composition of the present invention and the effect of improving the dispersibility of the polymer microparticles (B) in component (A). The interlayer further has the effect of increasing the crosslink density of the core layer and the effect of heightening the grafting efficiency of the shell layer.

Examples of the polyfunctional monomer include the same monomers enumerated above as examples of the polyfunctional monomer described above. Preferable are allyl methacrylate and triallyl isocyanurate.

Examples of the other vinyl monomer(s) include the aforementioned various monomers usable for the core layer, such as (meth)acrylate monomers, diene monomers, vinylarenes, and vinyl cyanides.

### <<Shell Layer>>

The shell layer present as the outermost layer of each polymer microparticle is one obtained by polymerizing one or more monomers for shell layer formation. It is preferable that the shell layer be constituted of a shell polymer which improves compatibility between the polymer microparticles and component (A) and which serves to enable the polymer microparticles to be dispersed in the state of primary particles in the curable resin composition of the present invention or in the cured product thereof.

Such shell polymer preferably has been grafted to the core layer. More accurately, it is preferable that the monomer components used for shell layer formation have been graft-polymerized with the core polymer constituting the core layer and that each shell polymer layer has been substantially chemically bonded to the core layer. Namely, the shell polymer is preferably formed by graft-polymerizing the monomers for shell layer formation in the presence of a core polymer. As a result, the shell layer has been graft-polymerized with this core polymer to cover a part or the whole of the core polymer. This polymerization operation can be accomplished by adding one or more monomers which are components constituting the shell polymer to a core polymer latex which has been prepared in an aqueous polymer latex state and is present as such and then polymerizing the monomers.

Preferable examples of the monomers for shell layer formation, from the standpoint of the compatibility and dispersibility of component (B) in the curable resin composition, include aromatic vinyl monomers, vinyl cyanide monomers, and (meth)acrylate monomers. (Meth)acrylate monomers are more preferable.

Use of a polyfunctional monomer having two or more polymerizable unsaturated bonds as a monomer for shell layer formation is preferable because the resultant polymer microparticles in the curable resin composition are prevented from swelling and because the curable resin composition tends to have a low viscosity and be easy to handle (workability is improved). Furthermore, due to the use of the polyfunctional monomer, the shell layer has polymerizable unsaturated bonds and is capable of participating in crosslinking when component (A) is cured, thereby improving the properties of the cured product.

The polyfunctional monomer is contained in an amount of preferably 1 to 20% by weight, more preferably 5 to 15% by weight, per 100% by weight of all the monomers for shell layer formation.

Examples of the aromatic vinyl monomers include styrene, α-methylstyrene, p-methylstyrene, and divinylbenzene.

Examples of the vinyl cyanide monomers include acrylonitrile and methacrylonitrile.

Examples of the (meth)acrylate monomers include methyl (meth)acrylate, ethyl (meth)acrylate, butyl (meth)acrylate, hydroxyethyl (meth)acrylate, and hydroxybutyl (meth)acrylate.

Examples of the polyfunctional monomer having two or more polymerizable unsaturated bonds include the same monomers enumerated above as examples of the polyfunctional monomer described above. Preferable are allyl methacrylate and triallyl isocyanurate.

In the present invention, it is preferable that the shell layer be made of a polymer of monomers for shell layer formation in which, for example, 0 to 35% by mass of styrene, 0 to 25% by mass of acrylonitrile, 20 to 100% by mass of methyl methacrylate, and 0 to 20% by mass of allyl methacrylate are combined. From this shell layer, a good balance between the desired toughness-improving effect and the mechanical properties can be achieved. In particular, incorporation of allyl (meth)acrylate as a constituent component is preferable because the interfacial adhesion to component (A) is expected to improve.

These monomer components may be used alone or in combination of two or more thereof.

The shell layer may be formed from monomers including other monomer component(s) besides the above-mentioned functional monomer components.

It is preferable that the shell layer have a graft ratio of 70% or higher (more preferably 80% or higher, even more preferably 90% or higher). If the graft ratio is less than 70%, the liquid resin composition may have an increased viscosity. Incidentally, the graft ratio herein is calculated by the following method.

First, an aqueous latex containing polymer microparticles was coagulated and dehydrated and finally dried to obtain powders of polymer microparticles.

Subsequently, the powders of polymer microparticles (2 g) were immersed in methyl ethyl ketone (MEK, 100 g) at 23° C. for 24 hours. Thereafter, the MEK-soluble matter was separated from the MEK-insoluble matter, and methanol-insoluble matter was separated from the MEK-soluble matter. The proportion of the MEK-insoluble matter to the sum of the MEK-insoluble matter and the methanol-insoluble matter was determined. Thus, the graft ratio was calculated.

### <<Process for Producing Polymer Microparticles>>

### (Process for Producing a Core Layer)

In cases when a polymer for forming the core layer constituting the polymer microparticles for use in the present invention is formed from monomers including at least one monomer (first monomer) selected from diene monomers (conjugated-diene monomers) and (meth)acrylate monomers, the core layer can be produced, for example, by emulsion polymerization, suspension polymerization, microsuspension polymerization, or the like. For example, the method described in WO 2005/028546 can be used.

In the case where the polymer constituting the core layer contains a polysiloxane polymer, the core layer can be formed, for example, by emulsion polymerization, suspension polymerization, microsuspension polymerization, or the like. For example, the method described in WO 2006/070664 can be used.

### (Methods for Forming a Shell Layer and an Interlayer)

The interlayer can be formed by polymerizing one or more monomers for interlayer formation by a known method. In cases when a rubber elastomer constituting the core layer was obtained as an emulsion, it is preferable that the polymerization of the monomers for interlayer formation be conducted by an emulsion polymerization method.

The shell layer can be formed by polymerizing one or more monomers for shell layer formation by a known method. When either core layer or polymer particle precursors configured of a core layer covered with an interlayer were obtained as an emulsion, it is preferable that the polymerization of the monomers for shell layer formation be conducted by an emulsion polymerization method. For example, the shell layer can be produced in accordance with the method described in WO 2005/028546.

Examples of emulsifiers (dispersants) usable in the emulsion polymerization include: anionic emulsifiers (dispersants) such as various acids including alkyl- or arylsulfonic acids represented by dioctylsulfosuccinic acid and dodecylbenzenesulfonic acid, (alkyl or aryl ether)sulfonic acids, alkyl- or arylsulfuric acids represented by dodecylsulfuric acid, (alkyl or aryl ether)sulfuric acids, alkyl- or aryl-substituted phosphoric acids, (alkyl or aryl ether)-substituted phosphoric acids, N-alkyl- or N-aryl-sarcosinic acids represented by dodecylsarcosinic acid, alkyl- or arylcarboxylic acids represented by oleic acid and stearic acid, and (alkyl or aryl ether)carboxylic acids, and alkali metal salts or ammonium salts of these acids; nonionic emulsifiers (dispersants) such as alkyl- or aryl-substituted polyethylene glycols; and dispersants such as polyvinyl alcohol), alkyl-substituted celluloses, polyvinylpyrrolidone, and poly(acrylic acid) derivatives. These emulsifiers (dispersants) may be used alone or in combination of two or more thereof.

It is preferable to minimize the amount of the emulsifier (dispersant) to be used, unless the dispersion stability of the aqueous latex of polymer microparticles is adversely affected thereby. In addition, it is desirable that the emulsifier (dispersant) has higher water solubility. Higher water solubility facilitates removal of the emulsifier (dispersant) by water washing and, hence, adverse influences on the cured product to be finally obtained can be easily avoided.

In the case of adopting an emulsion polymerization method, a known initiator, i.e., 2,2′-azobisisobutyronitrile, hydrogen peroxide, potassium persulfate, or ammonium persulfate, can be used as a thermally decomposable initiator.

It is also possible to use a redox initiator which includes a peroxide, e.g. an organic peroxide such as t-butyl peroxyisopropyl carbonate, p-menthane hydroperoxide, cumene hydroperoxide, dicumyl peroxide, t-butyl hydroperoxide, di-t-butyl peroxide and t-hexyl peroxide or an inorganic peroxide such as hydrogen peroxide, potassium persulfate and ammonium persulfate, and which optionally further includes, for example, a reducing agent such as sodium formaldehydesulfoxylate and glucose, a transition metal salt such as iron(II) sulfate, a chelating agent such as disodium ethylenediaminetetraacetate, or a phosphorus-containing compound such as sodium pyrophosphate.

Use of a redox initiator is preferable because the polymerization can be conducted even at such low temperatures that the peroxide is not substantially pyrolyzed, and because it is possible to set a polymerization temperature within a wider range. It is especially preferable to use, as the redox initiator, an organic peroxide such as cumene hydroperoxide, dicumyl peroxide and t-butyl hydroperoxide. The amount of the initiator to be used and the amounts of the reducing agent, transition metal salt, chelating agent, etc. to be used in the case of using a redox initiator can be within known ranges. When a monomer having two or more polymerizable unsaturated bonds is polymerized, a known chain-transfer agent can be used in an amount within a known range. A surfactant can be additionally used, and the amount thereof also is within a known range.

Conditions for the polymerization, including polymerization temperature, pressure, and deoxidization, can be within known ranges. The monomers for interlayer formation may be polymerized in one stage or in two or more stages. For example, a method in which the monomers for interlayer formation are added at a time to an emulsion of a rubber elastomer constituting the core layer, a method in which the monomers are continuously added thereto, and also a method in which an emulsion of a rubber elastomer constituting the core layer is introduced into a reactor into which the monomers for interlayer formation have been introduced beforehand can be employed to conduct polymerization.

### <Epoxy Resin (C)>

It is essential for the curable resin composition of the present invention that the content of the epoxy resin (C) therein be less than 0.5 parts by mass per 100 parts by mass the sum of component (A) and component (D), which is described later. Since component (C) is not incorporated into the crosslinking of the curable resin (A) which is the main component, contents thereof not less than 0.5 parts by mass may result in a cured product which has reduced heat resistance (Tg) or has a tackiness on its surface (surface tackiness) or which is prone to absorb solvents to reduce the chemical resistance. The content of component (C) relative to 100 parts by mass of the sum of component (A) and component (D) is preferably less than 0.3 parts by mass, more preferably less than 0.2 parts by mass, and especially preferably less than 0.1 parts by mass. It is most preferable not to contain component (C).

Examples of the epoxy resin include known epoxy resins such as bisphenol A epoxy resins, bisphenol F epoxy resins, novolac epoxy resins, glycidyl ester epoxy resins, hydrogenated bisphenol A (or F) epoxy resins, glycidyl ether epoxy resins, amino-containing glycidyl ether resins, and epoxy compounds obtained by causing a bisphenol A (or F) compound, a polybasic acid, etc. to undergo an addition reaction with these epoxy resins.

With respect to other epoxy group-containing compounds which have no polymerizable unsaturated bonds (e.g. monomers having a low molecular weight), it is preferable that the content thereof in the composition be low because there is a possibility that such epoxy group-containing compounds remaining unincorporated into the crosslinking of the curable resin (A) adversely affect the properties of the cured product. Specifically, the content thereof is preferably 0.5 parts by mass or less, more preferably 0.1 parts by mass or less, per 100 parts by mass of the sum of component (A) and component (D).

<Low-Molecular-Weight Compound (D) Having a Molecular Weight Less than 300 and Having at Least One Polymerizable Unsaturated Bond>

A low-molecular-weight compound (D) having a molecular weight less than 300 and having at least one polymerizable unsaturated bond in the molecule can be added to the curable resin composition of the present invention if necessary.

Due to the low molecular weight, the low-molecular-weight compound (D) having a molecular weight less than 300 and having at least one polymerizable unsaturated bond in the molecule lowers the viscosity of the curable resin composition of the present invention and improves the handleability. When the curable resin composition is cured, the low-molecular-weight compound is copolymerized with component (A) and thereby incorporated into the crosslink sites of the cured product. Furthermore, in the step described later in which the polymer microparticles (B) are dispersed as primary particles in a curable resin composition, component (D) is usable as a mixture with component (A) and has the effect of facilitating the production step due to the viscosity-lowering effect.

The mixing ratio (A/D) of component (A) to component (D) is not particularly limited, and is preferably 9/1 to 3/7 by weight. The upper limit of the A/D is more preferably 8/2, even more preferably 7/3. A/D ratios exceeding 9/1 may result in cases where the curable resin composition has such a high viscosity that it has poor handleability. The lower limit of the A/D is more preferably 4/6, even more preferably 5/5. A/D ratios less than 3/7 may result in cases where the cured product formed from the curable resin composition has a reduced thickness due to the volatility of component (D) or where component (B) aggregates when component (A) is added later, resulting in a decrease in toughness-improving effect.

Examples of the low-molecular-weight compound (D) include: aromatic-group-containing unsaturated monomers such as styrene and methylstyrene (vinyltoluene); nitrile group-containing unsaturated monomers such as acrylonitrile; (meth) acryloyl-containing compounds; compounds containing a —COOCH═CH₂ group, such as vinyl versatate and vinyl acetate; products of condensation reaction between a polyvalent carboxylic acid such as phthalic acid, adipic acid, maleic acid, or malonic acid and an unsaturated alcohol such as allyl alcohol; and polyfunctional ester monomers such as cyanuric acid allyl ester. Of these, (meth)acryloyl-containing compounds are preferable from the standpoint of the properties of the cured product, because these compounds have a polymerization rate which is close to that of component (A) and, when the curable resin composition containing this component (D) is cured, these compounds are apt to be incorporated into the crosslink sites of component (A).

Examples of the (meth)acryloyl-containing compounds include methyl (meth)acrylate, ethyl (meth)acrylate, n-propyl (meth)acrylate, isopropyl (meth)acrylate, cyclohexyl (meth)acrylate, n-hexyl (meth)acrylate, n-butyl (meth)acrylate, isobutyl (meth)acrylate, t-butyl (meth)acrylate, 2-ethylhexyl (meth)acrylate, n-octyl (meth)acrylate, lauryl (meth)acrylate, allyl (meth)acrylate, phenyl (meth)acrylate, glycidyl (meth)acrylate, benzyl (meth)acrylate, α-fluoromethyl acrylate, α-chloromethyl acrylate, α-benzylmethyl acrylate, α-cyanomethyl acrylate, α-acetoxyethyl acrylate, α-phenylmethyl acrylate, α-methoxymethyl acrylate, α-n-propylmethyl acrylate, α-fluoroethyl acrylate, α-chloroethyl acrylate, chloromethyl (meth)acrylate, hydroxyethyl (meth)acrylate, 2-hydroxyethyl (meth)acrylate, 2-butoxyethyl (meth)acrylate, 2-dimethylaminoethyl (meth)acrylate, 2-diethylaminoethyl (meth)acrylate, 2-hydroxypropyl (meth)acrylate, 2-chloroethyl (meth)acrylate, 2-cyanoethyl (meth)acrylate, 2-methoxyethyl (meth)acrylate, m-chlorophenyl (meth)acrylate, p-chlorophenyl (meth)acrylate, p-tolyl (meth)acrylate, m-nitrophenyl (meth)acrylate, p-nitrophenyl (meth)acrylate, 2,2,3,3-tetrafluoropropyl (meth)acrylate, 1,1,1,3,3,3-hexafluoroisopropyl (meth)acrylate, 2,2,3,4,4,4-hexafluorobutyl (meth)acrylate, tetrahydrofurfuryl (meth)acrylate, ethylene glycol monoethyl ether acrylate, ethylene glycol di(meth)acrylate, 1,4-butanediol di(meth)acrylate, hexanediol di(meth)acrylate, diethylene glycol di(meth)acrylate, and trimethylolpropane triacrylate. Of these (meth)acryloyl-containing compounds, the hydroxy-containing compounds are more preferable because such compounds enable modifications of the cured product through hybrid curing by radical crosslinking and urethane crosslinking, the hybrid curing being brought about by addition of an isocyanate compound to the curable resin composition.

Component (D) may be used alone or two or more components (D) may be used in combination.

### <Radical Initiator (E)>

In the present invention, a radical initiator (E) can be used. Component (E) is a hardener for both component (A) and component (D) and is an initiator for the crosslinking reaction of polymerizable unsaturated bonds (carbon-carbon double bond, etc.) contained in the resin. If necessary, component (E) is used together with a curing accelerator or a co-catalyst.

Examples of the radical initiator include: organic peroxides such as benzoyl peroxide, cumene hydroperoxide, dicumyl peroxide, lauroyl peroxide, di-t-butyl peroxide, t-butyl hydroperoxide, methyl ethyl ketone peroxide, t-butyl peroxybenozate, t-butyl peroxy-2-ethylhexanoate, and t-butyl peroxyoctanoate; and azo compounds such as azobisisobutyronitrile. From the standpoint of more effectively curing component (A), one or more peroxides selected from the group consisting of benzoyl peroxide, cumene hydroperoxide, dicumyl peroxide, and methyl ethyl ketone peroxide are preferable, and cumene hydroperoxide and methyl ethyl ketone peroxide are more preferable.

Component (E) may be used alone or two or more components (E) may be used in combination.

Radical initiators can be classified by optimal use temperature. There are initiators which function at relatively high temperatures, such as cumene hydroperoxide and dicumyl peroxide, and initiators which function at relatively low temperatures, such as benzoyl peroxide and azobisisobutyronitrile. Use of two or more components (E) differing in decomposition temperature is preferable because it is possible to obtain a curable resin composition which has curability in a wide temperature range. By using two or more components (E) in combination, for example, the curing initiation temperature of the curable resin composition is regulated to a relatively low temperature while the composition has curability even in the latter stage of curing in which the curing has proceeded and hence the composition has an elevated temperature. Thus, it is possible to increase the conversion rate of the polymerizable unsaturated bonds in the curable resin and improve the properties of the cured product.

In the case of using two or more components (E) in combination, the combination is not particularly limited. Examples thereof include a combination of cumene hydroperoxide and methyl ethyl ketone peroxide and a combination of t-butyl peroxybenozate and t-butyl peroxyoctanoate.

As an index to the decomposition temperature of component (E), 10-hour half-life temperature is mentioned. In the case of using two or more components (E) in combination, the difference in 10-hour half-life temperature between the two or more components (E) to be used is preferably 10° C. or larger, more preferably 20° C. or larger, especially preferably 20° C. or larger.

The curing accelerator is an additive which functions as a catalyst for the decomposition reaction (radical-formation reaction) of the radical initiator, and examples thereof include metal salts (cobalt salt, tin salt, lead salt, etc.) of naphthenic acid and octenoic acid. From the standpoint of making the toughness and appearance satisfactory, cobalt naphthenate is preferable. When a curing accelerator is added, it is preferable that the curing accelerator, in an amount of 0.1 to 1 part by mass per 100 parts by mass of component (A) according to the present invention, be added immediately before the curing reaction in order to prevent the curing reaction from occurring abruptly.

The co-catalyst is an additive for enabling the radical initiator to decompose even at low temperatures and to generate radicals at low temperatures, and examples thereof include amine compounds such as N,N-dimethylaniline, triethylamine, and triethanolamine. N,N-Dimethylaniline is preferable because an efficient reaction is possible. When a co-catalyst is added, it is preferable to add 0.01 to 0.5 parts by mass of the co-catalyst per 100 parts by mass of component (A) according to the present invention or 1 to 15 parts by mass of the co-catalyst per 100 parts by mass of the radical initiator.

### <Other Components>

In the present invention, other components can be used if necessary. Examples of the other components include colorants such as pigments and dyes, extender pigments, ultraviolet absorbers, antioxidants, stabilizers (anti-gelling agents), plasticizers, leveling agents, defoaming agents, silane coupling agents, antistatic agents, flame retardants, lubricants, thickeners, viscosity-reducing agents, shrinkage inhibitors, fibrous reinforcements, inorganic fillers, organic fillers, internal release agents, wetting agents, polymerization regulators, thermoplastic resins, desiccants, and dispersants.

Examples of the fillers include: inorganic fillers such as calcium carbonate, titanium oxide, aluminum oxide, aluminum hydroxide, magnesium hydroxide, dry-process silica, e.g. fumed silica, wet-process silica, crystalline silica, fused silica, bentonite, montmorillonite, calcium silicate, wollastonite, rectorite, kaolin, halloysite, glass powder, alumina, clay, talc, milled fibers, silica sand, river sand, diatomaceous earth, mica powder, gypsum, limestone powder, asbestos powder, fly ash, powdered marble, and carbon nanotubes; and organic fillers such as polymer beads. Among these fillers, at least one inorganic filler selected from the group consisting of calcium carbonate, aluminum hydroxide, dry-process silica, clay, talc, and glass powder are especially preferable. Such fillers may be used alone or in combination of two or more thereof.

When a filler is used, the amount thereof is preferably 5 to 400 parts by mass, more preferably 30 to 300 parts by mass, especially preferably 100 to 200 parts by mass, per 100 parts by mass of component (A) according to the present invention. If the amount of the filler is less than 5 parts by mass, a cured product having insufficient surface hardness and rigidity may be obtained. If the amount of the filler exceeds 400 parts by mass, the viscosity of the composition is prone to be too high, resulting in poor workability during molding. In addition, this composition may show impaired flowability in the mold to give a molded product having poorer mechanical property and the like.

The fillers may be ones which have been subjected to a coupling treatment in order to improve adhesion to component (A). Due to this, the properties, e.g. impact resistance, strength, and water resistance, of the cured product to be obtained can be improved. Coupling agents for the coupling treatment are not particularly limited, and examples thereof include silane coupling agents, chromium coupling agents, titanium coupling agents, aluminum coupling agents, and zirconium coupling agents. These coupling agents may be used alone or in combination of two or more thereof.

The thickeners are not particularly limited. However, inorganic thickeners such as the oxides and hydroxides of alkaline earth metals are preferable. Specific examples thereof include magnesium oxide, calcium oxide, magnesium hydroxide, and calcium hydroxide. It is also possible to use a thermoplastic polymer having swellability, e.g. poly(methyl methacrylate), as the thickener. These thickeners may be used alone or in combination of two or more thereof.

In the case of using a thickener, the amount thereof is preferably 0.1 to 30 parts by mass, more preferably 0.3 to 10 parts by mass, especially preferably 1 to 3 parts by mass, per 100 parts by mass of component (A) according to the present invention. Thickener amounts less than 0.1 parts by mass may result in cases where sufficient thickening is not attained. If the amount of the filler exceeds 30 parts by mass, the viscosity of the composition is prone to be too high, resulting in poor workability during modling.

Examples of the shrinkage inhibitors include polystyrene, polyethylene, poly(methyl methacrylate), poly(vinyl chloride), poly(vinyl acetate), polycaprolactam, saturated polyesters, styrene/acrylonitrile copolymers, vinyl acetate/styrene copolymers, styrene/divinylbenzene copolymers, methyl methacrylate/polyfunctional methacrylate copolymers, and rubbery polymers such as polybutadiene, polyisoprene, styrene/butadiene copolymers, and acrylonitrile/butadiene copolymers. These thermoplastic polymers may be ones into which a crosslinked structure has been partly introduced. These shrinkage inhibitors may be used alone or in combination of two or more thereof. In the case of using a shrinkage inhibitor, the amount thereof is preferably 2 to 20 parts by mass per 100 parts by mass of component (A) according to the present invention. Amounts thereof less than 2 parts by mass may result in cases where the shrinkage-inhibitive effect is insufficient. Shrinkage inhibitor amounts exceeding 20 parts by mass may result in cases where the molded product is reduced in transparency, etc. and is more costly.

Examples of the fibrous reinforcements include: inorganic fibers such as glass fibers, carbon fibers, metal fibers, and fibers made of ceramics; organic fibers made of aramids, polyesters, etc.; and natural fibers. However, the fibrous reinforcements are not particularly limited. Examples of the form of the fibers include roving, cloth, mat, woven fabric, chopped roving, and chopped strand, but the form thereof is not particularly limited. These fibrous reinforcements may be used alone or in combination of two or more thereof. In the case of using a fibrous reinforcement, the amount thereof is preferably 1 to 400 parts by mass per 100 parts by mass of component (A) according to the present invention. Amounts thereof less than 1 part by mass may result in cases where the reinforcing effect is insufficient, while amounts thereof exceeding 400 parts by mass may result in cases where the cured product has impaired surface state.

Examples of the internal release agents include stearic acid, zinc stearate, aluminum stearate, calcium stearate, barium stearate, stearamide, triphenyl phosphate, alkyl phosphates, general waxes, and silicone oils.

As the wetting agents, commercial ones can be used as such. Examples thereof include “W-995”, “W-996”, “W-9010”, “W-960”, “W-965”, and “W-990”, which are commercially available from BYK Japan K.K. A suitable one is selected and used in accordance with the purpose of the use.

Examples of the polymerization regulators include polymerization inhibitors such as hydroquinone, methylhydroquinone, methoxyhydroquinone, and t-butylhydroquinone. It is preferable that these polymerization regulators be sufficiently dissolved in a thermosetting resin beforehand. As the antioxidants, hindered phenol compounds such as 2,6-di-t-butylhydroxytoluene are preferably used.

As the colorants, known commercial inorganic pigments or organic pigments can be used. Likewise, usable are commercial benzophenone and the like as the ultraviolet absorbers, commercial silica and the like as the thixotropic agents, and commercial phosphoric esters and the like as the flame retardants.

### <Processes for Producing Curable Resin Composition>

The curable resin composition of the present invention is a composition formed of a curable resin composition which includes component (A) as the main component and in which polymer microparticles (B) have been dispersed in the state of primary particles.

For obtaining such composition in which polymer microparticles (B) have been dispersed in the state of primary particles, various methods can be utilized. Examples thereof include: a method in which polymer microparticles obtained in an aqueous latex state are contacted with component (A) and/or component (D), and the unnecessary components including water are thereafter removed; and a method in which polymer microparticles are temporarily extracted with an organic solvent and subsequently mixed with component (A) and/or component (D), and the organic solvent is thereafter removed. However, it is preferable to utilize the method described in WO 2005/28546. Specifically, it is preferable to prepare the composition by a method including in the following order, a first step in which an aqueous latex (specifically a reaction mixture resulting from production of polymer microparticles by emulsion polymerization) containing polymer microparticles (B) is mixed with an organic solvent having a solubility in 20° C. water of 5 to 40% by mass and then further mixed with excess water to aggregate the polymer particles, a second step in which the aggregated polymer microparticles (B) are separated and recovered from the liquid phase and then mixed again with an organic solvent to obtain an organic-solvent dispersion of the polymer microparticles (B), and a third step in which the organic-solvent dispersion is furthermore mixed with component (A) and/or component (D), and the organic solvent is thereafter distilled off.

In cases when aggregates each made of many primary particles aggregated together (e.g. powdery polymer microparticles) are mixed with a liquid resin, it is extremely difficult to disperse the polymer microparticles in the resin without aggregation even by applying a high mechanical shear force by means of a homogenizer or the like because the particles have considerably high physical cohesive force.

It is preferable that component (A) or a mixture of component (A) and component (D) be liquid at 23° C. because the third step is easy. It is more preferable that component (A) by itself be liquid at 23° C. The expression “liquid at 23° C.” means that the component or mixture has a softening point of 23° C. or lower and shows flowability at 23° C.

By additionally mixing component (A), component (C), component (D), component (E), and other components, if necessary, with the composition which was obtained through the steps described above, which contains polymer microparticles (B) dispersed in the state of primary particles in component (A) and/or component (D), a curable resin composition of the present invention containing polymer microparticles (B) dispersed in the state of primary particles is obtained.

### <Cured Product>

The present invention includes a cured product obtained by curing the curable resin composition of the present invention. Since the curable resin composition of the present invention contains polymer microparticles dispersed in the state of primary particles, a cured product containing polymer microparticles evenly dispersed can be easily obtained by curing the composition.

The present invention further relates to a cured product obtained by curing a curable resin composition which contains a curable resin (A) having two or more polymerizable unsaturated bonds in a molecule, and polymer microparticles (B), and which optionally further contains an epoxy resin (C) and a low-molecular-weight compound (D) having a molecular weight less than 300 and having at least one polymerizable unsaturated bond in a molecule, the content of component (B) being 1 to 100 parts by mass per 100 parts by mass of the sum of component (A) and component (D), the content of the epoxy resin (C) being less than 0.5 parts by mass per 100 parts by mass of the sum of component (A) and component (D), and the content of an epoxy (meth)acrylate being less than 99 parts by mass per 100 parts by mass of the sum of component (A) and component (D), wherein component (B) has been dispersed in the state of primary particles.

It can be easily understood that in the case where the polymer microparticles in a cured product are in a primarily dispersed state, the polymer microparticles in the uncured curable resin composition were also in a primarily dispersed state. This is because to primarily disperse aggregates in a resin is difficult as stated above.

### <Applications>

The curable resin composition of the present invention can be used in a wide range of molding techniques without particular limitations. Specifically, the composition can be molded by known molding techniques such as the hand lay-up method, spray-up method, pultrusion method, filament winding method, matched-die method, prepreg method, centrifugal molding, liquid molding, hot pressing, casting, injection molding, continuous laminating, resin transfer molding (RTM), vacuum bag molding, and cold pressing.

The curable resin composition of the present invention is suitable as a raw material for composites with glass fibers or carbon fibers, bulk molding compounds (BMCs), and sheet molding compounds (SMCs). Applications thereof also are not particularly limited. Specifically, however, the composition is suitable for use as or in: artificial-marble applications such as kitchen counters, lavatory sinks, bathtubs, unit baths, and wall materials; building/construction materials such as resin concrete, manhole covers, pools, flat sheets, corrugated sheets, septic tanks, water storage tanks, deck materials, utility poles, crossarms, and gratings; industrial materials and structural members, such as tanks, pressure vessels, industrial pipes, angle bars, ducts, scrubbers, factory pipelines, joints, pipes, corrugated plates, helmets, poles, blades for wind power generation, blade-reinforcing members, bonding pastes, radomes, cooling towers, and pipelines for pump-including systems in oil fields, such as those for sucker rods and pumps; components for automobiles or other vehicles, such as the bodies of golf carts, trucks, camping cars, or the like, and panels, air spoilers, and motors/dynamos for panel vans, refrigerator cars, or the like; fishing boats, pleasure boats, and ship components such as containers, floats, and propellers; electrical equipment and components, such as printed wiring boards, breakers, switch boxes, parabola antennas, and insulating boards; sports goods such as fishing rods, jet skis, snowboards, surfboards, and canoes; storage/transport goods such as trays, containers, and totes; structural members for bulletproof panels, railroad vehicle components, aircraft components, furniture, and musical instruments; and repair putties, decorative boards, and sheet materials such as decorative sheets. Alternatively, the composition is suitable for use in not only laminates, gel coats, lining materials, coating materials, adhesives, pastes, putties, and the like but also in applications in which radical-curable resins are generally used and are cured with ultraviolet rays or electron beams, such as adhesives, coating materials, inks, and potting.

Use of the curable resin composition of the present invention in applications such as laminates, gel coats, lining materials, coating materials, adhesives, and bonding pastes is more preferable because the curable resin composition of the present invention has excellent adhesion to the bases. Examples of the bases include steel sheets, coated steel sheets, aluminum, fiber-reinforced plastics (FRP), sheet molding compounds (SMC), ABS, PVC, polycarbonates, polypropylene, TPO, wood, and glass. In particular, the composition shows satisfactory secondary adhesion to FRPs such as fiber-reinforced unsaturated polyesters, and shows satisfactory secondary adhesion also to unsaturated polyester resins modified with dicyclopentadiene or the like.

### EXAMPLES

The present invention will be explained below in more detail by reference to Examples and Comparative Examples, but the invention should not be construed as being limited thereto. The invention can be suitably modified so long as the modifications suit the spirit described above and later, all such modifications being included in the technical scope of the invention. In the following Examples and Comparative Examples, “parts” and “%” mean “parts by mass” and “% by mass”.

### <Evaluation Methods>

First, methods for evaluating the curable resin compositions produced in the Examples and Comparative Examples are explained below.

### [1] Determination of Average Particle Diameter

The volume-average particle diameter (Mv) of the polymer particles dispersed in each aqueous latex was determined using Microtrac UPA150 (manufactured by Nikkiso Co., Ltd.). A dilution of the aqueous latex with deionized water was used as a test sample. For the determination, the refractive index of water and the refractive index of the polymer particles were input. The determination was made over a measurement period of 600 seconds after the sample concentration was regulated so as to result in a signal level in the range of 0.6 to 0.8.

### [2] Measurement of Fracture Toughness

Fracture toughness values K1c and G1c were measured at 23° C. using notched ¼-inch bars in accordance with ASTM D-5045.

### [3] Measurement of Tg

The glass transition temperature (Tg) of a cured product was measured using differential scanning calorimeter (DSC) Q100, manufactured by TA Instruments, Inc.

### 1. Formation of Core Layer

### Production Example 1-1

### Preparation of Polybutadiene Rubber Latex (R-1)

Into a 100 L pressure-resistant polymerizes were introduced 200 parts by mass of deionized water, 0.03 parts by mass of tripotassium phosphate, 0.25 parts by mass of potassium dihydrogen phosphate, 0.002 parts by mass of disodium ethylenediaminetetraacetate (EDTA), 0.001 parts by mass of ferrous sulfate heptahydrate (Fe), and 1.5 parts by mass of sodium dodecylbenzenesulfonate (SDS). Nitrogen replacement was sufficiently conducted with stirring to remove the oxygen. Thereafter, 100 parts by mass of butadiene (BD) was introduced into the system, and the contents were heated to 45° C. Thereinto were introduced 0.015 parts by mass of p-menthane hydroperoxide (PHP) and then 0.04 parts by mass of sodium formaldehydesulfoxylate (SFS) to initiate polymerization. At the time when four hours had passed since the polymerization initiation, 0.01 parts by mass of PHP, 0.0015 parts by mass of EDTA, and 0.001 parts by mass of Fe were introduced. At 10 hours after the polymerization initiation, the residual monomers were volatilized off at a reduced pressure to terminate the polymerization. Thus, a latex (R-1) containing polybutadiene rubber particles was obtained. The polybutadiene rubber particles contained in the obtained latex had a volume-average particle diameter of 0.10 μm.

### Production Example 1-2

### Preparation of Butadiene/Styrene Rubber Latex (R-2)

A latex (R-2) containing butadiene/styrene rubber particles was obtained in the same manner as in Production Example 1, except that 75 parts by mass of BD and 25 parts by mass of styrene (ST) were introduced into the system in place of the 100 parts by mass of BD. The butadiene/styrene rubber particles contained in the obtained latex had a volume-average particle diameter of 0.10 μm.

### 2. Preparation of Polymer Microparticles (Formation of Shell Layer)

### Production Example 2-1

### Preparation of core/shell polymer latex (L-1)

Into a 3 L glass vessel were introduced 1,575 parts by mass of the latex (R-1) obtained in Production Example 1-1 (corresponding to 510 parts by mass of the polybutadiene rubber particles) and 315 parts by mass of deionized water. The mixture was stirred at 50° C. while conducting nitrogen replacement. Thereto were added 0.012 parts by mass of EDTA, 0.006 parts by mass of Fe, and 0.24 parts by mass of SFS. Thereafter, a mixture of a grafting monomer (methyl methacrylate (MMA); 90 parts by mass) and 0.08 parts by mass of t-butyl hydroperoxide (TBP) was continuously added thereto over 1.2 hours to conduct graft polymerization. After completion of the addition, stirring was further continued for 2 hours to complete the reaction. Thus, a core/shell polymer latex (L-1) was obtained. The core/shell polymer contained in the obtained latex had a volume-average particle diameter of 0.11 μm.

### Production Example 2-2

### Preparation of Core/Shell Polymer Latex (L-2)

A core/shell polymer latex (L-2) was obtained in the same manner as in Production Example 2-1, except that the latex (R-2) was used in place of the latex (R-1). The core/shell polymer contained in the obtained latex had a volume-average particle diameter of 0.11 μm.

### Production Example 2-3

### Preparation of Core/Shell Polymer Latex (L-3)

A core/shell polymer latex (L-3) was obtained in the same manner as in Production Example 2-1, except that a mixture of 79 parts by mass of MMA and 11 parts by mass of triallyl isocyanurate (TAIC) was used as grafting monomers in place of the 90 parts by mass of MMA. The core/shell polymer contained in the obtained latex had a volume-average particle diameter of 0.11 μm.

### Production Example 2-4

### Preparation of Core/Shell Polymer Latex (L-4)

A core/shell polymer latex (L-4) was obtained in the same manner as in Production Example 2-1, except that the latex (R-2) was used in place of the latex (R-1) and that a mixture of 81 parts by mass of MMA and 9 parts by mass of allyl methacrylate (ALMA) was used as grafting monomers in place of the 90 parts by mass of MMA. The core/shell polymer contained in the obtained latex had a volume-average particle diameter of 0.11 μm.

### 3. Preparation of Dispersions Containing Polymer Microparticles (B) Dispersed in Curable Resin

### Production Example 3-1 to Production Example 3-4

### Preparation of Dispersions (M-1) to (M-4)

Methyl ethyl ketone (MEK) was introduced in an amount of 132 g into a 1 L mixing vessel having a temperature of 25° C. Each of the aqueous core/shell polymer latexes (L-1) to (L-4) obtained respectively in Production Examples 2-1 to 2-4 was introduced thereinto with stirring in an amount of 132 g (corresponding to 40 g of the polymer microparticles). After the mixture was evenly mixed, 200 g of water was introduced at a feed rate of 80 g/min. After completion of the feeding, the stirring was immediately stopped. As a result, a slurry formed from floatable aggregates and an aqueous phase containing some of the organic solvent was obtained. Next, 360 g of the aqueous phase was discharged through a discharge port located in the lower part of the vessel, leaving the aggregates which contained some of the aqueous phase. Ninety grams of MEK was added to the obtained aggregates, and the mixture was evenly mixed to obtain a dispersion in which the core/shell polymer had been evenly dispersed. Eighty grams of a polyester resin (A-1: neopentyl glycol/isophthalic acid polyester methacrylate having two carbon-carbon double bonds in the molecule and being liquid at 23° C.), as a component (A), was added to the dispersion and mixed. The MEK was removed from this mixture with a rotary evaporator. Thus, dispersions (M-1) to (M-4) were obtained in which polymer microparticles had been dispersed in a polyester-based curable resin.

### Production Example 3-5

### Preparation of Dispersion (M-5)

A dispersion (M-5) in which polymer microparticles had been dispersed in a polyester-based curable resin was obtained in the same manner as in Production Example 3-4, except that a mixture of 48 g of polyester resin (A-1) and 32 g of 2-hydroxypropyl methacrylate (HPMA) as component (D) was used in place of 80 g of the polyester resin (A-1).

### Production Example 3-6

### Preparation of Dispersion (M-6)

A dispersion (M-6) in which polymer microparticles had been dispersed in an epoxy resin was obtained in the same manner as in Production Example 3-1, except that a bisphenol A epoxy resin (C-1: Epon 828, manufactured by Hexion Specialty Chemicals Inc.) as component (C) was used in place of the polyester resin (A-1).

### Production Example 3-7

### Preparation of Dispersion (M-7)

A dispersion (M-7) in which polymer microparticles had been dispersed in a polyester-based curable resin was obtained in the same manner as in Production Example 3-4, except that a mixture of 72 g of polyester resin (A-1) and 48 g of HPMA as component (D) was used in place of 80 g of the polyester resin (A-1).

### Production Example 3-8

### Preparation of Dispersion (M-8)

A dispersion (M-8) in which polymer microparticles had been dispersed in a polyester-based curable resin was obtained in the same manner as in Production Example 3-4, except that a mixture of 36 g of polyester resin (A-1) and 24 g of HPMA as component (D) was used in place of 80 g of the polyester resin (A-1).

### Examples 1 to 8 and Comparative Examples 1 to 6

In accordance with the recipes shown in Table 1, the following components were weighed out: a vinyl ester resin (A-2: Hydrex 33375-00, manufactured by Reichhold Inc.) which was a mixture of component (A) and component (D), the dispersions (M-1) to (M-6) obtained in Production Examples 3-1 to 3-6, an epoxy resin as component (C), 2-hydroxypropyl methacrylate (HPMA) as component (D), cumene hydroperoxide (CHP) as component (E), and a 6% cobalt naphthenate solution (CoN) as a curing accelerator. The components were sufficiently mixed to obtain curable resin compositions. These compositions were cured at 23° C. for 24 hours and then post-cured at 120° C. for 2 hours to thereby obtain cured products. The results of tests for determining the fracture toughness and Tg of these cured products are shown in Table 1.

It can be seen that the cured products of the Examples all have transparency, indicating that the polymer microparticles (B) have been completely primarily dispersed in the curable resins. In particular, the cured products of Examples 5, 7, and 8 had high transparency.

TABLE 1

| | | Examples | | | | | | | |
|---|---|---|---|---|---|---|---|---|---|
| Composition (parts by weight) | | 1 | 2 | 3 | 4 | 5 | 6 | 7 | 8 |
| Curable resin (A), or | A-2 | 94 | 88 | 82 | 87.6 | 88 | 88 | 88 | 88 |
| mixture of curable resin (A) and low- | A-1 | | | | | | | | |
| molecular-weight compound (D) | | | | | | | | | |
| Dispersion of polymer microparticles (B) | M-1 | 6 | 12 | 18 | 12 | | | | |
| in curable resin (A) | M-2 | | | | | 12 | | | |
| | M-3 | | | | | | 12 | | |
| | M-4 | | | | | | | 12 | |
| | M-5 | | | | | | | | 12 |
| Dispersion of polymer microparticles (B) | M-6 | | | | | | | | |
| in epoxy resin (C) | | | | | | | | | |
| Epoxy resin (C) | C-1 | | | | 0.4 | | | | |
| Low-molecular-weight compound (D) | HPMA | | | | | | | | |
| Radical initiator (E) | CHP | 1.25 | 1.25 | 1.25 | 1.25 | 1.25 | 1.25 | 1.25 | 1.25 |
| 6% Cobalt naphthenate solution | CoN | 0.6 | 0.6 | 0.6 | 0.6 | 0.6 | 0.6 | 0.6 | 0.6 |
| Content of (B) per 100 parts by mass of the sum of | | 2.0 | 4.2 | 6.4 | 4.2 | 4.2 | 4.2 | 4.2 | 4.2 |
| component (A) and component (D) (parts by mass) | | | | | | | | | |
| Content of (C) per 100 parts by mass of the sum of | | 0.0 | 0.0 | 0.0 | 0.4 | 0.0 | 0.0 | 0.0 | 0.0 |
| component (A) and component (D) (parts by mass) | | | | | | | | | |
| K_{1C} | MPa · m^{-1/2} | 0.75 | 0.91 | 1.00 | 0.91 | 0.81 | 0.87 | 0.78 | 0.79 |
| G_{1C} | J/m² | 157 | 247 | 307 | 246 | 202 | 229 | 189 | 194 |
| Tg | ° C. | 130 | 130 | 129 | 128 | 129 | 129 | 129 | 124 |

| | | Comparative Examples | | | | | |
|---|---|---|---|---|---|---|---|
| Composition (parts by weight) | | 1 | 2 | 3 | 4 | 5 | 6 |
| Curable resin (A), or | A-2 | 100 | 92 | 96.8 | 92 | 94 | 88 |
| mixture of curable resin (A) and low- | A-1 | | 8 | | | | |
| molecular-weight compound (D) | | | | | | | |
| Dispersion of polymer microparticles (B) | M-1 | | | | | | |
| in curable resin (A) | M-2 | | | | | | |
| | M-3 | | | | | | |
| | M-4 | | | | | | |
| | M-5 | | | | | | |
| Dispersion of polymer microparticles (B) | M-6 | | | | | 6 | 12 |
| in epoxy resin (C) | | | | | | | |
| Epoxy resin (C) | C-1 | | | | 8 | | |
| Low-molecular-weight compound (D) | HPMA | | | 3.2 | | | |
| Radical initiator (E) | CHP | 1.25 | 1.25 | 1.25 | 1.25 | 1.25 | 1.25 |
| 6% Cobalt naphthenate solution | CoN | 0.6 | 0.6 | 0.6 | 0.6 | 0.6 | 0.6 |
| Content of (B) per 100 parts by mass of the sum of | | 0.0 | 0.0 | 0.0 | 0.0 | 2.1 | 4.5 |
| component (A) and component (D) (parts by mass) | | | | | | | |
| Content of (C) per 100 parts by mass of the sum of | | 0.0 | 0.0 | 0.0 | 8.7 | 4.3 | 9.1 |
| component (A) and component (D) (parts by mass) | | | | | | | |
| K_{1C} | MPa · m^{-1/2} | 0.49 | 0.49 | 0.52 | 0.48 | 0.76 | 0.95 |
| G_{1C} | J/m² | 67 | 67 | 71 | 63 | 157 | 251 |
| Tg | ° C. | 129 | 127 | 125 | 112 | 122 | 108 |

### Examples 9 to 16 and Comparative Examples 7 to 12

In accordance with the recipes, shown in Table 2, the following components were weighed out: a vinyl ester resin (A-3: Dion 9102-70, manufactured by Reichhold Inc.) which was a mixture of component (A) and component (D), the dispersions (M-1) to (M-6) obtained in Production Examples 3-1 to 3-6, an epoxy resin as component (C), 2-hydroxypropyl methacrylate (HPMA) as component (D), methyl ethyl ketone peroxide (MEKP) as component (E), and a 6% cobalt naphthenate solution (CoN) as a curing accelerator. The components were sufficiently mixed to obtain curable resin compositions. These compositions were cured at 23° C. for 24 hours and then post-cured at 120° C. for 2 hours to thereby obtain cured products. The results of tests for determining the fracture toughness and Tg of these cured products are shown in Table 2.

It can be seen that the cured products of the Examples all have transparency, indicating that the polymer microparticles (B) have been completely primarily dispersed in the curable resins. In particular, the cured products of Examples 13, 15, and 16 had high transparency.

TABLE 2

| Composition (parts by weight) | | 9 | 10 | 11 | 12 | 13 | 14 | 15 | 16 |
|---|---|---|---|---|---|---|---|---|---|
| Curable resin (A), or | A-3 | 94 | 88 | 82 | 87.6 | 88 | 88 | 88 | 88 |
| mixture of curable resin (A) and low- | A-1 | | | | | | | | |
| molecular-weight compound (D) | | | | | | | | | |
| Dispersion of polymer microparticles (B) | M-1 | 6 | 12 | 18 | 12 | | | | |
| in curable resin (A) | M-2 | | | | | 12 | | | |
| | M-3 | | | | | | 12 | | |
| | M-4 | | | | | | | 12 | |
| | M-5 | | | | | | | | 12 |
| Dispersion of polymer microparticles (B) | M-6 | | | | | | | | |
| in epoxy resin (C) | | | | | | | | | |
| Epoxy resin (C) | C-1 | | | | 0.4 | | | | |
| Low-molecular-weight compound (D) | HPMA | | | | | | | | |
| Radical initiator (E) | MEKP | 1.25 | 1.25 | 1.25 | 1.25 | 1.25 | 1.25 | 1.25 | 1.25 |
| 6% Cobalt naphthenate solution | CoN | 0.1 | 0.1 | 0.1 | 0.1 | 0.1 | 0.1 | 0.1 | 0.1 |
| Content of (B) per 100 parts by mass of the sum of | | 2.0 | 4.2 | 6.4 | 4.2 | 4.2 | 4.2 | 4.2 | 4.2 |
| component (A) and component (D) (parts by mass) | | | | | | | | | |
| Content of (C) per 100 parts by mass of the sum of | | 0.0 | 0.0 | 0.0 | 0.4 | 0.0 | 0.0 | 0.0 | 0.0 |
| component (A) and component (D) (parts by mass) | | | | | | | | | |
| K_{1C} | MPa · m^{-1/2} | 1.17 | 1.65 | 2.06 | 1.65 | 1.43 | 1.56 | 1.36 | 1.38 |
| G_{1C} | J/m² | 449 | 988 | 1604 | 988 | 785 | 907 | 724 | 729 |
| Tg | ° C. | 114 | 112 | 111 | 111 | 112 | 112 | 112 | 110 |

| | | Comparative Examples | | | | | |
|---|---|---|---|---|---|---|---|
| Composition (parts by weight) | | 7 | 8 | 9 | 10 | 11 | 12 |
| Curable resin (A), or | A-3 | 100 | 92 | 96.8 | 92 | 94 | 88 |
| mixture of curable resin (A) and low- | A-1 | | 8 | | | | |
| molecular-weight compound (D) | | | | | | | |
| Dispersion of polymer microparticles (B) | M-1 | | | | | | |
| in curable resin (A) | M-2 | | | | | | |
| | M-3 | | | | | | |
| | M-4 | | | | | | |
| | M-5 | | | | | | |
| Dispersion of polymer microparticles (B) | M-6 | | | | | 6 | 12 |
| in epoxy resin (C) | | | | | | | |
| Epoxy resin (C) | C-1 | | | | 8 | | |
| Low-molecular-weight compound (D) | HPMA | | | 3.2 | | | |
| Radical initiator (E) | MEKP | 1.25 | 1.25 | 1.25 | 1.25 | 1.25 | 1.25 |
| 6% Cobalt naphthenate solution | CoN | 0.1 | 0.1 | 0.1 | 0.1 | 0.1 | 0.1 |
| Content of (B) per 100 parts by mass of the sum of | | 0.0 | 0.0 | 0.0 | 0.0 | 2.1 | 4.5 |
| component (A) and component (D) (parts by mass) | | | | | | | |
| Content of (C) per 100 parts by mass of the sum of | | 0.0 | 0.0 | 0.0 | 8.7 | 4.3 | 9.1 |
| component (A) and component (D) (parts by mass) | | | | | | | |
| K_{1C} | MPa · m^{-1/2} | 0.76 | 0.75 | 0.78 | 0.84 | 1.25 | 1.76 |
| G_{1C} | J/m² | 174 | 179 | 178 | 201 | 499 | 1024 |
| Tg | ° C. | 114 | 112 | 110 | 99 | 109 | 101 |

### Examples 17 to 23 and Comparative Examples 13 to 18

In accordance with the recipes shown in Table 3, the following components were weighed out: a polyester resin (A-4: Polylite 31696-15, manufactured by Reichhold Inc.) which was a mixture of component (A) and component (D), the dispersions (M-1), (M-2), and (M-5) to (M-8) obtained in Production Examples 3-1, 3-2, and 3-5 to 3-8, an epoxy resin as component (C), 2-hydroxypropyl methacrylate (HPMA) as component (D), methyl ethyl ketone peroxide (MEKP) as component (E), and a 6% cobalt naphthenate solution (CoN) as a curing accelerator. The components were sufficiently mixed to obtain curable resin compositions. These compositions were cured at 23° C. for 24 hours and then post-cured at 120° C. for 2 hours to thereby obtain cured products. The results of tests for determining the fracture toughness and Tg of these cured products are shown in Table 3.

It can be seen that the cured products of the Examples all have transparency, indicating that the polymer microparticles (B) have been completely primarily dispersed in the curable resins. In particular, the cured products of Examples 18 to 23 had high transparency.

TABLE 3

| | | Examples | | | | | | |
|---|---|---|---|---|---|---|---|---|
| Composition (parts by weight) | | 17 | 18 | 19 | 20 | 21 | 22 | 23 |
| Curable resin (A), or | A-4 | 88 | 88 | 94 | 88 | 82 | 84 | 90 |
| mixture of curable resin (A) and low- | A-1 | | | | | | | |
| molecular-weight compound (D) | | | | | | | | |
| Dispersion of polymer microparticles (B) | M-1 | 12 | | | | | | |
| in curable resin (A) | M-2 | | 12 | | | | | |
| | M-5 | | | 6 | 12 | 18 | | |
| | M-7 | | | | | | 16 | |
| | M-8 | | | | | | | 10 |
| Dispersion of polymer microparticles (B) | M-6 | | | | | | | |
| in epoxy resin (C) | | | | | | | | |
| Epoxy resin (C) | C-1 | | | | | | | |
| Low-molecular-weight compound (D) | HPMA | | | | | | | |
| Radical initiator (E) | MEKP | 1 | 1 | 1 | 1 | 1 | 1 | 1 |
| 6% Cobalt naphthenate solution | CoN | 0.1 | 0.1 | 0.1 | 0.1 | 0.1 | 0.1 | 0.1 |
| Content of (B) per 100 parts by mass of the sum of | | 4.2 | 4.2 | 2.0 | 4.2 | 6.4 | 4.2 | 4.2 |
| component (A) and component (D) (parts by mass) | | | | | | | | |
| Content of (C) per 100 parts by mass of the sum of | | 0.0 | 0.0 | 0.0 | 0.0 | 0.0 | 0.0 | 0.0 |
| component (A) and component (D) (parts by mass) | | | | | | | | |
| K_{1C} | MPa · m^{-1/2} | 0.81 | 0.74 | 0.66 | 0.73 | 0.82 | 0.74 | 0.72 |
| G_{1C} | J/m² | 209 | 178 | 130 | 170 | 204 | 173 | 168 |
| Tg | ° C. | 167 | 167 | 168 | 162 | 157 | 157 | 159 |

| | | Comparative Examples | | | | | |
|---|---|---|---|---|---|---|---|
| Composition (parts by weight) | | 13 | 14 | 15 | 16 | 17 | 18 |
| Curable resin (A), or | A-4 | 100 | 92 | 92 | 92 | 88 | 81 |
| mixture of curable resin (A) and low- | A-1 | | 8 | 4.8 | | | |
| molecular-weight compound (D) | | | | | | | |
| Dispersion of polymer microparticles (B) | M-1 | | | | | | |
| in curable resin (A) | M-2 | | | | | | |
| | M-5 | | | | | | 18 |
| | M-7 | | | | | | |
| | M-8 | | | | | | |
| Dispersion of polymer microparticles (B) | M-6 | | | | | 12 | |
| in epoxy resin (C) | | | | | | | |
| Epoxy resin (C) | C-1 | | | | 8 | | 1 |
| Low-molecular-weight compound (D) | HPMA | | | 3.2 | | | |
| Radical initiator (E) | MEKP | 1 | 1 | 1 | 1 | 1 | 1 |
| 6% Cobalt naphthenate solution | CoN | 0.1 | 0.1 | 0.1 | 0.1 | 0.1 | 0.1 |
| Content of (B) per 100 parts by mass of the sum of | | 0.0 | 0.0 | 0.0 | 0.0 | 4.5 | 6.5 |
| component (A) and component (D) (parts by mass) | | | | | | | |
| Content of (C) per 100 parts by mass of the sum of | | 0.0 | 0.0 | 0.0 | 8.7 | 9.1 | 1.1 |
| component (A) and component (D) (parts by mass) | | | | | | | |
| K_{1C} | MPa · m^{-1/2} | 0.53 | 0.54 | 0.56 | 0.51 | 0.90 | 0.81 |
| G_{1C} | J/m² | 82 | 84 | 87 | 79 | 235 | 202 |
| Tg | ° C. | 174 | 167 | 162 | 149 | 148 | 153 |

### Examples 24 and 25 and Comparative Example 19

In accordance with the recipes shown in Table 4, a polyester resin (A-4: Polylite 31696-15, manufactured by Reichhold Inc.) which was a mixture of component (A) and component (D), the dispersions (M-1) and (M-2) obtained in Production Examples 3-1 and 3-2, and benzoyl peroxide (BPO) as component (E) were weighed out and sufficiently mixed together to obtain curable resin compositions. These compositions were cured at 80° C. for 1.5 hours to thereby obtain cured products. The appearance of each cured product was examined and the cracks and the transparency of the cured products were evaluated. The test results are shown in Table 4.

TABLE 4

| | | | | Comparative |
|---|---|---|---|---|
| | | Examples | | Example |
| Composition (parts by weight) | | 24 | 25 | 19 |
| Mixture of curable resin (A) and low- | A-4 | 88 | 88 | 100 |
| molecular-weight compound (D) | | | | |
| Dispersion of polymer microparticles | M-1 | 12 | | |
| (B) in curable resin (A) | M-2 | | 12 | |
| Radical initiator (E) | BPO | 1 | 1 | 1 |

| | | | |
|---|---|---|---|
| Content of (B) per 100 parts by mass of the | 42 | 42 | 0.0 |
| sum of component (A) and component (D) | | | |
| (parts by mass) | | | |
| Content of (C) per 100 parts by mass of the | 0.0 | 0.0 | 0.0 |
| sum of component (A) and component (D) | | | |
| (parts by mass) | | | |
| Cracks | Absent | Absent | Present |
| Transparency | Slightly hazy | Transparent | Transparent |

It can be seen from these results that the cured products of the present invention have improved toughness and cracking resistance without being considerably reduced in heat resistance (Tg) or transparency.

Incidentally, the cured products of Comparative Examples 4 to 6, 10 to 12, and 16 to 18, which had contained an epoxy resin as component (C), showed relatively low values of Tg.

### Example 26 and Comparative Example 20

The composition of Example 2 and glass fibers were used to superpose one layer, by the hand lay-up method, on a surface of a laminate formed from an unsaturated polyester resin modified with dicyclopentadiene and from glass fibers. Thereafter, the composition was cured under the conditions of 23° C.×24 hours plus 120° C.×2 hours (Example 26). Meanwhile, the same procedure was conducted except that the composition of Comparative Example 1 was used in place of the composition of Example 2 (Comparative Example 20). The adhesive force at the secondary bonding interface was evaluated by conducting a 90-degree peel test. In Comparative Example 20 (wherein the composition of Comparative Example 1 was used), delamination occurred at the secondary bonding interface. On the other hand, in Example 26 (wherein the composition of Example 2 was used), material failure occurred in the laminate, which was the base obtained using a dicyclopentadiene-modified unsaturated polyester resin. It can be seen that the curable resin composition of the present invention has excellent adhesion to the base (secondary adhesion).

### Example 27

The viscosity of the dispersion (M-8) obtained in Production Example 3-8 was measured. The value of viscosity was measured using a cone-and-plate viscometer (Spindle CPE-52, manufactured by BROOKFIELD Inc.) under the conditions of 23° C. and a shear rate of 1 s⁻¹. The viscosity thereof was 17 Pa·s.

### Comparative Example 21

Thirty-six grams of polyester resin (A-1) as component (A), 24 g of HPMA as component (D), and 40 g of core/shell polymer microparticles (ZEFIAC F351, manufactured by Aica Kogyo Co., Ltd.) in a powder form composed of aggregates of primary particles were mixed together using a planetary centrifugal mixer to obtain a composition (component (A), 36% by mass; component (D), 24% by mass; polymer microparticles, 40% by mass) similar to M-8 in Example 27. This composition was examined for viscosity under the same conditions as in Example 27. As a result, the viscosity thereof was 1,600 Pa·s or higher.

It can be seen from these results that the curable resin composition of the present invention has a low viscosity.

### Example 28

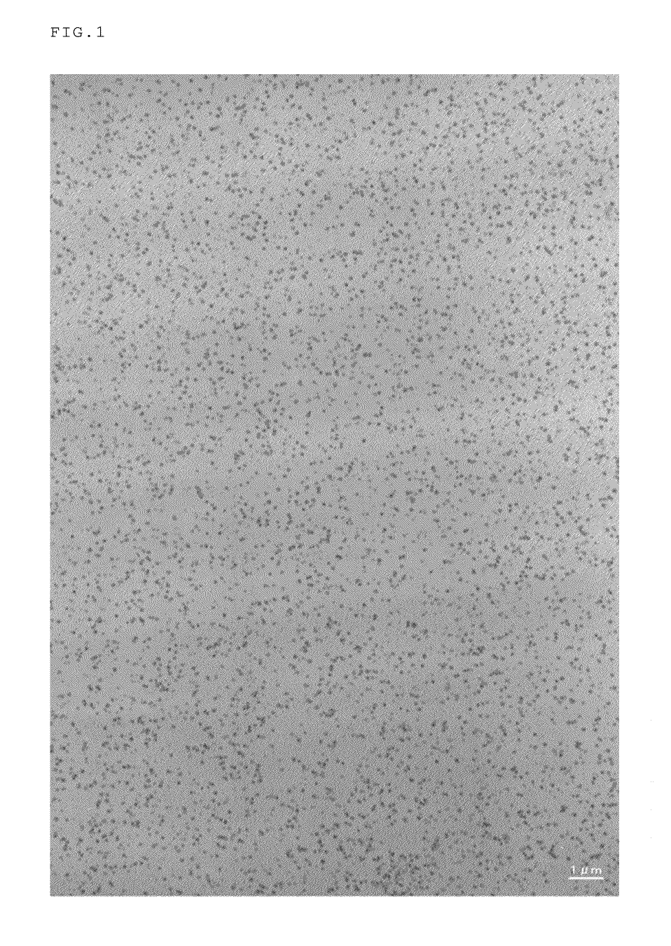

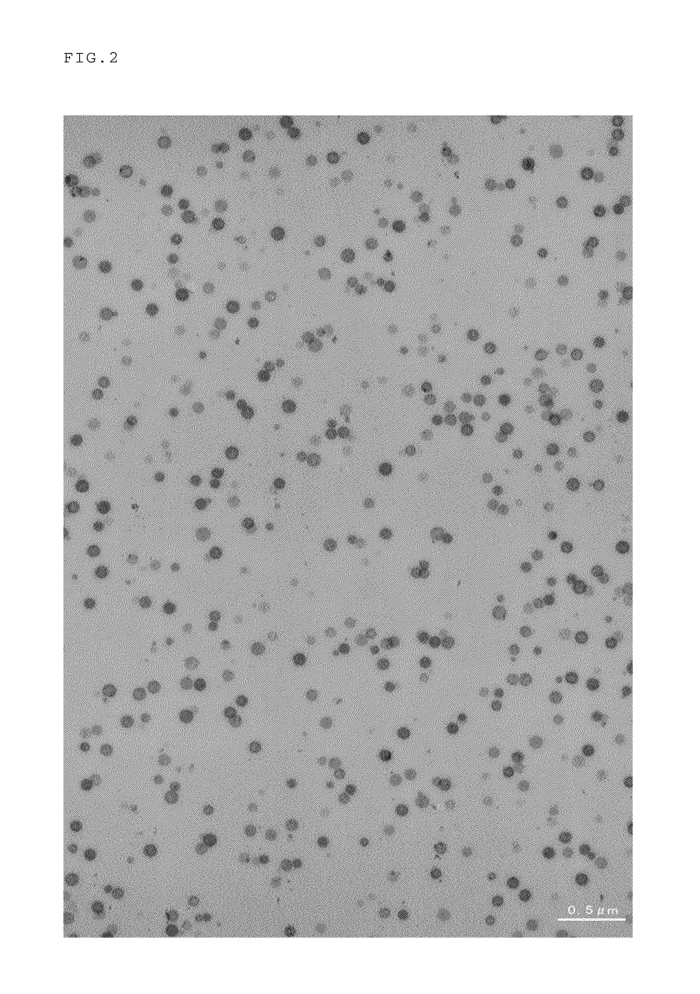

Using a planetary centrifugal mixer, 6.25 g of the dispersion (M-8) obtained in Production Example 3-8, 93.75 g of polyester resin (A-1) as component (A), 0.5 g of methyl ethyl ketone peroxide (MEKP) as component (E), and 0.15 g of a 6% cobalt naphthenate solution (CoN) as a curing accelerator were stirred and degassed. Thus, a curable resin composition containing component (B) in an amount of 2.5% by mass was obtained. This composition was poured into the space between two glass plates between which a spacer having a thickness of 3 mm had been sandwiched. The composition was cured under the conditions of 23° C.×24 hours plus 120° C.×2 hours to obtain a cured product having a thickness of 3 mm. An ultra-thin sample was cut out of the cured product by means of a microtome, dyed with ruthenium oxide, and examined with a transmission electron microscope for the dispersed state of the polymer microparticles. Photomicrographs thereof having magnifications of 10,000 times and 40,000 times are shown in FIG. 1 and FIG. 2, respectively.

### Comparative Example 22

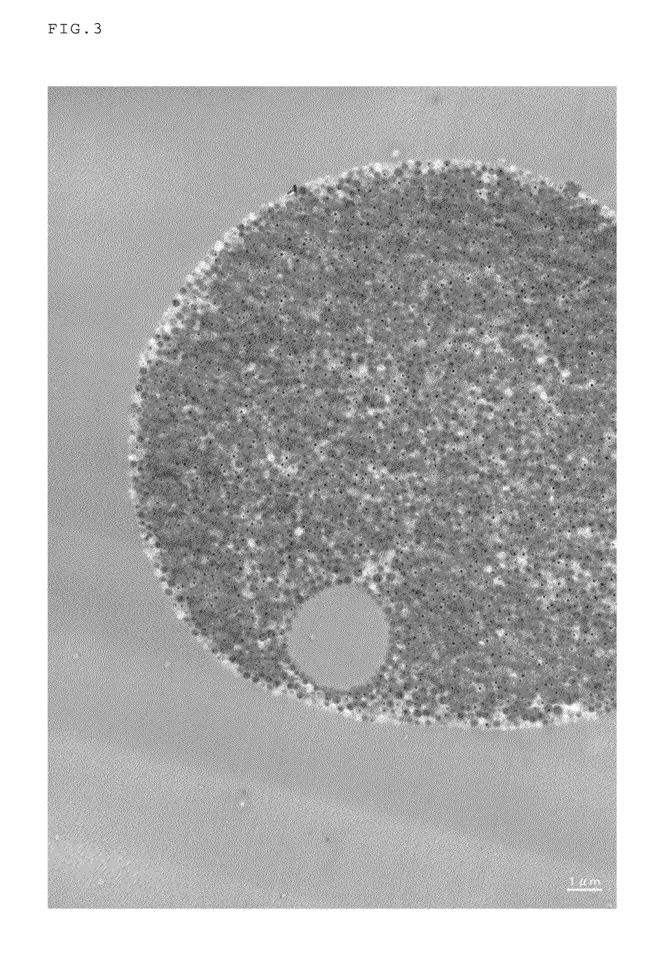

Using a planetary centrifugal mixer, 96 g of polyester resin (A-1) as component (A), 1.5 g of HPMA as component (D), 2.5 g of core/shell polymer microparticles (ZEFIAC F351, manufactured by Aica Kogyo Co., Ltd.) in a powder form composed of aggregates of primary particles, 0.5 g of methyl ethyl ketone peroxide (MEKP) as component (E), and 0.15 g of a 6% cobalt naphthenate solution (CoN) as a curing accelerator were stirred and degassed. Thus, a curable resin composition containing polymer microparticles in an amount of 2.5% by mass was obtained. A cured product was formed from this composition under the same conditions as in Example 28, and was examined with a transmission electron microscope for the dispersed state of the polymer microparticles. A photomicrograph thereof having a magnification of 10,000 times is shown in FIG. 3.

It can be seen from these results that in the curable resin composition of the present invention and in the cured product of the present invention, component (B) has been dispersed in the state of primary particles.

1. A curable resin composition, comprising
a curable resin (A) having two or more polymerizable unsaturated bonds in a molecule, and
polymer microparticles (B),
the curable resin composition optionally further comprising an epoxy resin (C) and a low-molecular-weight compound (D) having a molecular weight less than 300 and having at least one polymerizable unsaturated bond in a molecule,
wherein the content of component (B) is 1 to 100 parts by mass per 100 parts by mass of the sum of component (A) and component (D),
the content of the epoxy resin (C) is less than 0.5 parts by mass per 100 parts by mass of the sum of component (A) and component (D),
component (A) has an epoxy (meth)acrylate content less than 99 parts by mass per 100 parts by mass of the whole component (A), and
component (B) has been dispersed in the state of primary particles in the curable resin composition.

2. The curable resin composition according to claim 1,
wherein component (A) or a mixture of component (A) and component (D) is liquid at 23° C.

3. The curable resin composition according to claim 1,
wherein component (A) is a curable resin having a main chain which is constituted of repeating units that contain ester bonds.

4. The curable resin composition according to claim 3,
wherein component (A) is an unsaturated polyester.

5. The curable resin composition according to claim 3,
wherein component (A) is a polyester (meth)acrylate.

6. The curable resin composition according to claim 1,
wherein component (A) is one or more curable resins selected from the group consisting of epoxy (meth)acrylates, urethane (meth)acrylates, polyether (meth)acrylates, and acrylated (meth)acrylates.

7. The curable resin composition according to claim 1, which contains no epoxy (meth)acrylate.

8. The curable resin composition according to claim 1,
wherein component (B) has a volume-average particle diameter of 10 to 2,000 nm.

9. The curable resin composition according to claim 1,
wherein component (B) has a core/shell structure.

10. The curable resin composition according to claim 9,
wherein component (B) has a core layer containing at least one rubber selected from the group consisting of diene-based rubbers, (meth)acrylate-based rubbers, and organosiloxane-based rubbers.

11. The curable resin composition according to claim 10,
wherein the diene-based rubbers are butadiene rubbers and/or butadiene/styrene rubbers.

12. The curable resin composition according to claim 9,
wherein component (B) has a shell layer formed by graft-polymerizing, with a core layer, at least one monomer component selected from the group consisting of aromatic vinyl monomers, vinyl cyanide monomers, and (meth)acrylate monomers.

13. The curable resin composition according to claim 9,
wherein component (B) has a shell layer formed by graft-polymerizing, with a core layer, a monomer component which contains a polyfunctional monomer having two or more polymerizable unsaturated bonds.

14. The curable resin composition according to claim 1, which does not contain the epoxy resin (C).

15. The curable resin composition according to claim 1,
wherein component (D) is a (meth)acryloyl-containing compound.

16. The curable resin composition according to claim 15,
wherein the (meth)acryloyl-containing compound has a hydroxy group.

17. The curable resin composition according to claim 1, further comprising a radical initiator (E).

18. A cured product obtained by curing the curable resin composition according to claim 1.

19. A cured product obtained by curing a curable resin composition which contains a curable resin (A) having two or more polymerizable unsaturated bonds in a molecule, and polymer microparticles (B), and which optionally further contains an epoxy resin (C) and a low-molecular-weight compound (D) having a molecular weight less than 300 and having at least one polymerizable unsaturated bond in a molecule,
the content of component (B) being 1 to 100 parts by mass per 100 parts by mass of the sum of component (A) and component (D),
the content of the epoxy resin (C) being less than 0.5 parts by mass per 100 parts by mass of the sum of component (A) and component (D), and
component (A) having an epoxy (meth)acrylate content less than 99 parts by mass per 100 parts by mass of the whole component (A),
wherein component (B) has been dispersed in the state of primary particles.

20. A process for producing the curable resin composition according to claim 1, comprising:
a first step of mixing an aqueous latex containing component (B) with an organic solvent that has a solubility in 20° C. water of 5 to 40% by mass and thereafter further mixing the mixture with excess water to aggregate component (B);
a second step of separating and recovering the aggregated component (B) from a liquid phase and mixing again the aggregated component (B) with an organic solvent to obtain an organic-solvent dispersion of component (B); and
a third step of further mixing the organic-solvent dispersion with component (A) and/or component (D), and then distilling off the organic solvent.
